(19) United States
(12) Patent Application Publication
(10) Pub. No.: US 2025/0231367 A1
(43) Pub. Date: Jul. 17, 2025

(54) SYSTEMS, METHODS, AND APPARATUSES FOR EVENT DETECTION FOR A TRANSMISSION CABLE OR LINE-BASED SYSTEM

(71) Applicant: Comcast Cable Communications, LLC, Philadelphia, PA (US)

(72) Inventors: Jonathan Leech, Englewood, CO (US); Lawrence Wolcott, JR., Englewood, CO (US); Andrew M. Frederick, Centennial, CO (US); Venk Mutalik, Centennial, CO (US)

(21) Appl. No.: 18/411,531

(22) Filed: Jan. 12, 2024

(51) Int. Cl. G02B 6/46; G01V 1/28; G01V 1/30; G01V 8/02

(52) U.S. Cl. CPC G02B 6/562; G01V 1/288; G01V 1/30; G01V 8/02; G01V 2210/142; G01V 2210/63

(57) ABSTRACT

Methods, systems, and apparatuses are provided for detecting events in proximity to one or more transmission lines or cables of a data, power, communications, and/or content data transmission system. Data indicating an event may be received. The data may indicate movement or deflection of a portion of the transmission line or cable. A location of the portion of the transmission line or cable may be determine. The location may be determined based on the received data. A classification of the event may be determined. For example, the classification of the event may be based on the data on the received data and the determined location. For example, the classification of the event may be determined by a machine-learning model. A response may be caused. The response may be associated with the portion of the cable. The response may be based on the classification of the event.

### BACKGROUND

Content, power, data, and/or communication delivery disruptions along a cable or other line-based transmission systems are unpredictable and can have many root causes. In certain cases, the disruptions are caused due to damage to a transmission cable or line or portion of a transmission cable or line through which the content, power, data, or communications is being delivered. The damage to the transmission cable or line may be caused by third parties who may or may not be aware of the location of the particular transmission cable or line. These third parties may also not be aware of how their actions are creating a potential or likelihood for damaging the transmission cable or line. While there are conventional systems for determining when a transmission cable or line has been damaged and actions to take based on the damage caused to the transmission cable or line, these systems are reactive and only occur once the transmission system has been negatively affected. Detecting events near cables or lines of the transmission system that have the potential to damage the transmission cable or line and determining responsive actions prior to the transmission cable or line being damaged limits the negative effects to the transmission system as a whole.

### SUMMARY

It is to be understood that both the following general description and the following detailed description are exemplary and explanatory only and are not restrictive. Methods and systems for communications management are described.

Methods, systems, and apparatuses are provided for detecting events in proximity to one or more transmission cables or lines of a transmission system, such as a content transmission system, a data transmission system, an electrical power transmission system, or a communication transmission system. Data indicating an event may be received. The data may indicate movement or deflection of a portion of a transmission cable or line. A location of the portion of the transmission cable or line may be determined. The location may be determined based on the received data. A classification of the event may be determined. For example, the classification of the event may be based on the data on the received data and the determined location. For example, the classification of the event may be determined by a machine-learning model. A response may be caused. The response may be associated with the portion of the transmission cable or line. The response may be based on the classification of the event.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system;

FIG. 2 shows a perspective view of an example transmission cable or line;

FIGS. 3A-3F shows examples of force data received from a portion of an example transmission cable or line;

FIG. 4 shows an example system;

FIG. 5 shows a flowchart for an example method;

FIG. 6 shows an example system;

FIG. 7 shows a flowchart for an example method;

FIG. 8 shows a flowchart for an example method;

FIG. 9 shows a flowchart for an example method; and

FIG. 10 shows a flowchart for an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

“Content data,” as the phrase is used herein, may also be referred to as “content,” “content items,” “content information,” “content asset,” “multimedia asset data file,” or simply “data” or “information”. Content data may be any information or data that may be licensed to one or more individuals (or other entities, such as business or group). Content data may be electronic representations of video, audio, text and/or graphics, which may be but is not limited to electronic representations of videos, movies, or other multimedia. The content data described herein may be electronic representations of music, spoken words, or other audio. In some cases, content data may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic ad insertion data (.csv), Adobe® Photoshop® (.PSD) format or some other format for electronically storing text, graphics and/or other information whether such format is presently known or developed in the future. Content data may be any combination of the above-described formats.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

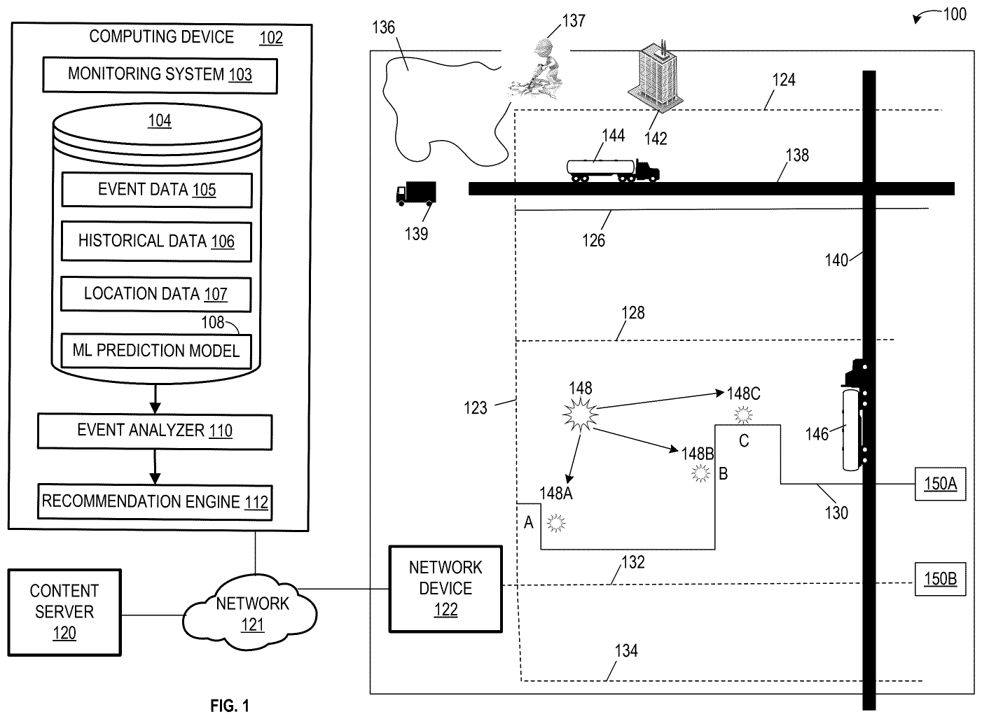

FIG. 1 shows an example system 100 for determining events occurring along a data, power, communication, and/or content data transmission system and causing response actions to take place in response to the determined events. The system 100 may comprise a content delivery network, a data network, a content distribution network, or any other network or content distribution system that one skilled in the art would appreciate. The system 100 may comprise computing device 102 and content server 120. FIG. 1 shows the computing device 102 as comprising a plurality of modules and components and the content server 120 as comprising a no modules and components, for example only. It is to be understood that each of the computing device 102 and the content server 120 shown in the system 100 may comprise additional components/modules, other than those that are shown in FIG. 1.

For example, while not shown in FIG. 1, the computing device 102 may comprise the content server 120 or the content server 120 may comprise all of the components of the computing device 102. Other example configurations are possible.

The computing devices 102 and the content server 120 may communicate via a network 121. The network 121 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 121 via a variety of transmission paths along the data, power, communication, and/or content data transmission system, including wireless paths (e.g., satellite paths, Wi-Fi paths, cellular paths, etc.) and terrestrial paths (e.g., wired paths (e.g., coaxial cable or fiber-optic), a direct feed source via a direct line, etc.).

For example, the network 121 may include a plurality of terrestrial cable or line paths. Each of the terrestrial cable or line paths may comprise one or more transmission cables or lines 123-134. Each of the one or more transmission cables or lines 123-134 may comprise high voltage transmission lines, coaxial cables, or fiber-optic cables. Each of the one or more transmission cables or lines 123-134 may be configured to transmit data, electrical power, communications, and/or content data (e.g., content items such as video content items, audio content items, audio/video content items, or data) along the path of the particular transmission cable or line 123-134 between the content server 120 and one or more access points 150A-B. For example, each of the one or more transmission cables or lines 123-134 may be configured to transmit the content data from a network device 122 (e.g., a cable modem termination system (CMTS), an optical line terminal (OLT), a gateway device, or the like) to the one or more access points 150A-B.

The one or more transmission cables or lines 123-134 may be distributed along a plurality of different paths across the data transmission system (e.g., a content data transmission system, a power transmission system, a communications transmission system, etc.). All or a portion of each of the one or more transmission cables or lines 123-134 may extend, be laid, or otherwise run through one or more transmission mediums. For example, transmission mediums may comprise air, water (e.g., saltwater or fresh water), soil, concrete, asphalt, or the like. For example, events occurring in or adjacent to the transmission cables or lines extending through a particular medium may generate and transmit forces at a different level, at a different speed, and/or for a longer distance within the particular medium than within another particular medium.

For example, the one or more transmission cables or lines 123, 124, 128, 132, 134 may be positioned or laid under the surface of the ground (e.g., underground) and may extend through a soil medium. Furthermore, as shown in FIG. 1, portions of the one or more transmission cable or line 124 may extend through the medium soil, while other portions may extend through the medium concrete as the transmission cable or line 124 passes through the concrete sidewalk or foundation area of the building 142 and yet other portions may extend through the medium asphalt as the transmission cable or line 124 is run through or under the roadway 140. Similarly, portions of the one or more transmission cables or lines 128, 132, 134 may extend through the medium soil, when buried underground, while other portions may extend through the medium asphalt as the transmission cable or line is run through or under the roadway 140. This portion of the one or more transmission cables or lines 123, 124, 128, 132, 134 may be exposed to forces, such as impact forces, vibration, earthquakes, strain, and pressure gradient forces (e.g., blast overpressure, shock waves, sound waves, etc.).

For example, another portion of the one or more transmission cables or lines 126, 130 may be positioned or strung along one or more poles so as to extend through the medium air above the surface of the ground. This portion of the one or more transmission cables or lines 126, 130 may be exposed to forces generated by wind, precipitation (rain, ice, snow, sleet, etc.) that the other portion of the one or more transmission cables or lines 123, 124, 128, 132, 134 are not exposed to. In addition, this portion of the one or more transmission cables or lines 126, 130 may be exposed to other forces, such as vibration, earthquakes, strain, and pressure gradient forces (e.g., blast overpressure, shock waves, sound waves, etc.).

For example, when a truck, such as truck 139 or 144, drives along a road 138, the movement of the truck 144 along the road 138 will generate forces (e.g., impact and vibration forces, sonic wave forces, etc.) within the ground (e.g., soil, concrete, asphalt) or within the air that may be detected by one or more portions of the transmission cable or line 124. For example, construction equipment 137 (e.g., a jackhammer, backhoe, pile-driver, etc.) at a construction site 136 may generate forces (e.g., impact and vibration forces) within the ground or in the air that may be detected by one or more portions of the transmission cable or line 124. For example, when a truck 146, drives along a road 140, the movement of the truck 146 along the road 138 will generate forces (e.g., impact forces, vibration forces, sonic wave forces) within the ground or in the air that may be detected by one or more portions of the transmission cable or line 124, 128, 132, 134. For example, when an explosion 148 (e.g., a gunshot, bomb, fireworks, etc.) occurs, it may generate a sound wave (e.g., a sonic wave force) that moves through the air and may be detected 148A, 148B, 148C by one or more portions A, B, C, of the transmission cable or line 130 that extends through the air or other transmission cables or lines that extend through the ground.

For example, the transmission cable or line may be a fiber-optic cable, wherein portions of the fiber-optic cable (e.g., a plurality of glass fibers) are used for transmission of data, communications, or content data (e.g., content data carrying fibers), and another portion of the fiber-optic cable (e.g., one or more glass fibers, dark fibers, unused fibers or sensing fibers) may not be in use for transmission of data, communications, or content data and could optionally be used as a sensing fiber. For example, one or both of the sensing fiber and the content data carrying fiber may be used to sense for events along the length of the transmission cable or line to provide feedback to the computing device 102. For example, the forces caused by the event (e.g., the truck running along the road) may cause a deflection in the sensing fiber or one of the content data carrying fibers that causes a change in the index of refraction for that portion of the fiber of that portion of the transmission cable or line. As a result of the force on the sensing fiber or one of the content data carrying fibers, the index of refraction of the sensing fiber or one of the content data carrying fibers may expand and/or compress based on the changes in magnitude of the force applied to the sensing fiber or one of the content data carrying fibers. These changes in the index of refraction may be, via the transmission cable or line 124, sent to, determined by, or detected by the computing device 102 via the network 121 in the form of index of refraction (IoR) data. The computing device 102 may receive the IoR data (e.g., these changes and magnitudes of the index of refraction as a function of time). The IoR data may also include a location of the portion of the transmission cable or line 124 wherein the sensing fiber or one of the content data carrying fibers indicated the particular changes in the index of refraction. The same event may be detected by the sensing fiber along other portions of the transmission cable or line 124. While the same event may be detected, the changes in the index or refraction and the magnitude of the index of refraction at this other portion of the transmission cable or line 124 may be different and may occur at a different time. The differences in magnitude and time of an event being detected along different portions of the fiber-optic cable or line 124 will allow the computing device 102 to determine the event that is occurring, based on a machine-learning model, and the location of the event.

For example, the transmission cable or line 130 may be a fiber-optic cable, an electrical, power line, another transmission line, or a coaxial cable. For example, one or more portions of the transmission cable or line may be used or configured to be used as a sensor that can sense events (e.g., soundwaves, shockwaves, vibration, motion, etc.) and provide feedback to the computing device 102. For example, the sensors may be virtual sensors, in that a portion of the coaxial cable or fiber-optics or other elements within the transmission cable or line 130 may be used as a sensor along different portions of the length of the transmission cable or line 130. For example, a computing device may evaluate changes in Rayleigh scattering within the particular fiber-optic elements of a fiber-optic cable to determine changes to the IQ error-vector for the portion of the fiber-optic cable and sense events. For example, the computing device may evaluate changes in impedance in a portion of a power line, other transmission line, or coaxial cable to determine changes to the IQ error-vector for the portion of the power line, other transmission line, or coaxial cable and sense events.

For example, the generated forces of an event 148 may cause one or more portions of the transmission cable or line 130 to vibrate. The vibration of the one or more portions of the transmission cable or line 130 changes the physical properties of that portion of the transmission cable or line, including the amount of Rayleigh scattering, in a fiber-optic cable, or the impedance levels, in a power line, other transmission line, or coaxial cable, that occurs along that portion of the transmission cable or line 130. The variations over time in Rayleigh scattering or impedance along a portion of the transmission cable or line 130 cause changes over time in the IQ error-vector of the code words transmitted along the transmission cable or line 130. The changes in Rayleigh scattering or impedance levels resulting in changes to the IQ error-vector for each frame for each subcarrier in orthogonal frequency-division multiple access (OFDMA), caused by the event 148 and detected by the sensor in each portion of the transmission cable or line 130 may be, via the transmission cable or line 130, sent to, determined by, or detected by the computing device 102 via the network 121 in the form of IQ error-vector data. The computing device 102 may receive the Rayleigh scattering data, for fiber-optic cables, or impedance levels, for power lines, other transmission lines, or coaxial cables, continuously or at a sampled rate from the one or more transmission cables or lines and may use that data to determine changes to the IQ error-vectors and detect the event 148. The IoR data or impedance data received from the transmission cable or line may also include a location of the portion of the transmission cable or line 124 that sensed the vibration.

For example, the same event 148, in the form of 148A, 148B, 148C, may be detected along multiple portions A, B, C of the transmission cable or line 130. For example, the event 148 may be a gunshot or an explosion that generates sonic waves that spread out from the location of the event 148. Those sonic waves 148A, 148B, 148C may impact the transmission cable or line 130 at corresponding locations A, B, C at different times and with differing levels of magnitude, causing a different vibration, length of vibration, or level of vibration on the transmission cable or line 130 at A, B, and C. The different vibration at A, B, and C of transmission cable or line 130 may generate different levels of IQ error-vector data at sensors within the transmission cable or line near or adjacent to A, B, and C. The varying IQ error-vector data may be received by the computing device 102 and evaluated to determine, based on a machine-learning model, the event 148 that is occurring and the location of the event 148. While the event 148 above is described as a gunshot or explosion, this is for example purposes only, as any type of event that imparts a force or vibration on the transmission cable or line may be evaluated to determine the type of event and the location of the event along the particular transmission cable or line.

The computing device 102 may include a monitoring system 103. The monitoring system 103 may receive the IoR data and/or the IQ error-vector data from the transmission cables or lines 123-134 via the network 121 or another network. The monitoring system 103 may also receive pre-equalization data from the network device 122. For example, when the network device 122 receives data or messages from an access point, such as access points 150A-B, the network device 122 may evaluate the data or message to determine if there are linear distortions that can be reduced by having the access point 150A-B adjust the access point's signal. When impairments are detected, the network device 122 sends to the access point 150A-B one or more equalizer adjustment values, called coefficients, which the access point 150A-B applies for upstream messages or data sent to the network device 122. These coefficients skew a signal, sent by the access point 150A-B via one or more transmission cables or lines 123-134 to the network device 122, back to its desired shape when received by the network device 122. The monitoring system 103 may determine or receive the equalizer adjustment values in the form of pre-equalization data associated with each of the one or more transmission cables or lines 123-134 from the one or more network devices 122 via the network 121 or another network and may subsequently use the pre-equalization data when determining events occurring near one of the transmission cables or lines 123-134.

The computing device 102 may also include one or more databases 104 or data storage elements/device. While the example of FIG. 1 shows the computing device 102 including the one or more databases 104, in other examples, the one or more databases 104 may be distributed locally or remotely from the computing device 102 and may provide the data associated with the one or more databases 104 to the computing device via the network 121 or another network.

The one or more databases 104 may comprise event data 105. For example, the event data 105 may comprises IoR data, IQ error-vector data, pre-equalization data, or other data associated with the transmission cables or lines 123-134 and/or the content transmission system. The one or more databases 104 may comprise historical data 106. The historical data 106 may comprise historical IoR data, historical IQ error-vector data, historical IoR data and an indication of the event associated with the IoR data, historical IQ error-vector data and an indication of the event associated with the IQ error-vector data; historical IoR data and an indication of the impact (e.g., no damage, data transmission disruption, transmission cable or line damage level, transmission cable or line severed, etc.) resulting to the transmission cable or line associated with the IoR data, historical IQ error-vector data and an indication of the impact resulting to the transmission cable or line associated with the IQ error-vector data, a library of events associated with particular IoR patterns and/or error-vector patterns detected in each type of medium (e.g., air, water (e.g., saltwater or fresh water), soil, concrete, asphalt, or the like) or environment, and/or a library of IoR patterns (e.g., backscatter variability over time and frequency) and/or error-vector patterns showing physical impairment at the location for the transmission cable or line. The historical data 106 may be used by a machine-learning computer to train a prediction model to identify, from the IoR data or the IQ error-vector data, the type of event occurring near the particular location of the transmission cable or line providing the IoR data or the IQ error-vector data and probability or likelihood of damage to the transmission cable or line by the current event.

The one or more databases 104 may comprise location data 107. For example, the location data 107 may comprise a topology database of what the data transmission system looks like. This may include an identification of each transmission cable or line in the data, content, power, or communication transmission system, the environment associated with each particular transmission cable or line, the locations through which each particular transmission cable or line is run, the portions and/or location of each particular transmission cable or line extending through a particular medium (e.g., air, water (e.g., saltwater or fresh water), soil, concrete, asphalt, or the like), the velocity of propagation for the transmission cable or line or portion of the transmission cable or line, the location of nodes, the location of amplifiers, the location of taps, the location of splitters, the location of splices along the transmission system, the location of roads, construction sites, and the like through which the data transmission system, and each particular transmission cable or line passes or is adjacent to.

The one or more databases 104 may comprise a machine-learning prediction model 108. The machine-learning prediction model 108 may be determined by a machine-learning system or computer that is part of the computing device 102 or separate from the computing device 102. The machine-learning prediction model 108 may be used to evaluate the received IoR data or the matrix of data generated from the IQ error-vector data to determine the likely events that may have caused vibration or movement of a transmission cable or line at a particular location. The machine-learning prediction model 108 may determine the likelihood or probability that the event (if it continues) will cause a negative impact (e.g., damage the transmission cable or line, disrupt or increase noise in data, power, content, or communication transmission along the transmission cable or line, sever the transmission cable or line) at that location and the level of impact that will occur. For example, the machine-learning prediction model 108 may be determined or derived from one or more portions of the historical data 106. For example, the machine-learning prediction model 108 may be determined based on previous events and the generated IoR data or laboratory created IoR data for each medium that the transmission cables or lines pass through and models of impact (e.g., patters of backscatter variability over time and frequency) caused to the particular transmission cable or line based on the event. For example, the machine-learning prediction model 108 may be determined based on previous events and the generated matrix data from the generated IQ error-vector data from the transmission cables or lines or matrix data from laboratory created events causing IQ error-vector data on transmission cables or lines for each medium that the transmission cable or line passes through and models of impact caused to the particular transmission cable or line based on the event.

The computing device 102 may comprise an event analyzer 110. For example, the event analyzer 110 may be a machine-learning system. For example, the event analyzer 110 may evaluate the received IoR data from a transmission cable or line in the event data 105 and the location and/or medium that the transmission cable or line is passing through at the particular location, from the location data 107, and using the prediction model from the machine-learning prediction model 108, determine the probability or likelihood that a particular event caused the vibration or movement of the transmission cable or line at the location within that particular medium. The event analyzer 110 may determine the severity of the event or the probability or likelihood that the event (if it continues) will cause a negative impact (e.g., damage the transmission cable or line, disrupt or increase noise in data transmission along the transmission cable or line, sever the transmission cable or line) at that location and the level of impact that will occur. The event analyzer 110 may output a result of the determinations (e.g., the determined event and the severity of the event or probability or likelihood the event will cause a negative impact to the transmission cable or line at the location). For example, the event analyzer 110 may output the result of the determinations to a display and/or a user device (e.g., a personal computer, laptop computer, smart phone, table computer, smart watch, or the like).

For example, the event analyzer 110 may receive the IQ error-vector data (e.g., the error-vector for multiple frames for each subcarrier in OFDMA) for a transmission cable or line that occurred at a particular location. The event analyzer 110 applies an inverse fast Fourier transformation to convert the error-vector for each frame from a frequency domain to a time domain and interleave I (e.g., amplitude of the in-phase signal) and Q (e.g., amplitude of the quadrature signal) values into one another (e.g., [I1, Q1, I2, Q2] etc.) to create modified error-vector data. The event analyzer 110 may normalize the modified error-vector data based on pre-equalization data for the particular transmission cable or line and by summing 1 to N adjacent values, where N can be any number between 2 and two times the subcarrier count, which would represent the entire transmission cable or line as a single sensor. For example, summation of the modified error-vector data may increase sensitivity but decrease time or distance resolution. For example, the summing of the modified error-vector data may vary such that different spans of the transmission cable or line may have different values of N (e.g., subcarriers of the signal on the transmission cable or line) depending on normalization and sensitivity for the transmission cable or line. The event analyzer 110 may determine the sum of 1 to P frames for the summed modified error-vector data. The event analyzer 110 may compute the delta between each frame, or sum of P frames, to create the matrix data. The resulting matrix data is a matrix with the horizontal rows being the independent sensors and the vertical rows being changes in that particular sensor over time. Frequencies of each sensor (e.g., each vertical column of the matrix) may be determined by fast Fourier transform or audio playback. Distance between each sensor may be determined by the number of values summed. The location of a particular sensor (e.g., latitude and longitude for the sensor) may be calculated using the determined distance and a geographic information system with transmission cable or line locations from the location data 107. The event analyzer 110 may determine the event occurring near or adjacent a sensor of the transmission cable or line by comparing the matrix of data derived from the IQ error-vector data to known patterns caused by events in the historical data 106 using the prediction model 108. The event analyzer 110 may determine the severity of the event or the probability or likelihood that the event (if it continues) will cause a negative impact (e.g., damage the transmission cable or line, disrupt or increase noise in data transmission along the transmission cable or line, sever the transmission cable or line) at that location and the level of impact that will occur. The event analyzer 110 may output a result of the determinations (e.g., the determined event and the severity of the event or probability or likelihood the event will cause a negative impact to the transmission cable or line at the location). For example, the event analyzer 110 may output the result of the determinations to a display and/or a user device (e.g., a personal computer, laptop computer, smart phone, table computer, smart watch, or the like).

The event analyzer 110 may also determine the location of the event that caused the movement or vibration in the transmission cable or line. For example, the event analyzer 110 may determine the location of the event based on a matrix of data from multiple sensors on a transmission cable or line or from one or more sensors from multiple transmission cables or lines. For example, the event analyzer 110 may, based on the location of the sensor determined above generated by an event, for the multiple sensors of the transmission cable or line of one or more sensors of multiple transmission cables or lines, and the time that each sensor detected the event, determine the location of the event (e.g., event 148) based on triangulation or another technique. For example, using triangulation, a system of equations may be evaluated to determine a location of the event based on best fit. For example, the sensors A, B, and C on transmission cable or line 130 may each detect 148A, 148B, 148C the event 148 at a different time and with a different amount of movement or vibration. Based on the magnitude of the force applied at each sensor A, B, C, as evidenced by the amount of movement or vibration of the transmission cable or line 130 at that particular sensor, and the time the event 148A-C was detected, the event analyzer 110 may determine the location (e.g., how far away from the transmission cable or line 130, and in which direction from the transmission cable or line 130) of the event 148.

The computing device 102 may comprise a recommendation engine 112. The recommendation engine 112 may receive the determined event and the severity of the event or probability or likelihood the event will cause a negative impact to the transmission cable or line at the location and determine the action to take in response. For example, the response may be based on the event, the severity of the event, the probability of the event, and/or the likelihood of the event. For example, the recommendation engine 112 may receive the determined event and severity or probability or likelihood the event will cause a negative impact the transmission cable or line from the event analyzer 112. For example, the recommendation engine 112 may determine to reroute the electrical power, data, communications and/or content data being sent through the transmission cable or line to another transmission cable or line in the data, power, communication and/or content data transmission system. For example, the recommendation engine 112 may then cause the electrical power, data, communications, and/or content data to be rerouted through that other transmission cable or line. For example, the recommendation engine 112 may send a message or cause a message to be sent to the content server 120 to reroute the electrical power, data, communications, and/or content data through the determined other transmission cable or line. For example, the recommendation engine 112 may determine to move the transmission cable or line or a portion of the transmission cable or line. For example, the transmission cable or line 124 may be positioned close to the construction site 136. The recommendation engine 112 may determine that moving the portion of the transmission cable or line 124 near the construction site 136 may be the best option for preventing subsequent damage to the transmission cable or line 124, as caused by the event or similar events that are likely to occur due to the construction site's proximity to the transmission cable or line 124. The recommendation engine 112 may cause one or more people to be dispatched to move the transmission cable or line 124 or a portion thereof. The recommendation engine 112 may determine to provide additional protection to the transmission cable or line at the location where the event was detected by the transmission cable or line. For example, the recommendation engine 112 may cause one or more people to be dispatched to the location and to install or add additional protection to the transmission cable or line. The additional protection may be in the form of signage or notifying the cause of the event of the impacts that the event is having on the transmission cable or line and the data, power, communication, and/or content data transmission system at large.

The system 100 may comprise the content server 120. The content server 120 may comprise one or more devices (e.g., an encoder, decoder, transcoder, packager, etc.). The content server 120 may generate and/or output portions of content (e.g., content items, content data) for consumption (e.g., output) via the network 121 and one or more transmission cables or lines 123-134 of the power, data, communications, and/or content data transmission system. For example, the content server 120 may convert raw versions of content (e.g., broadcast content items, streaming content items, video-on-demand content items) into compressed or otherwise more “consumable” versions suitable for playback/output by user devices, media devices, and other consumer-level computing devices. For ease of explanation, the description herein may use the phrase “content server” in the singular form. However, it is to be understood that the content server 120 may comprise a plurality of servers and/or a plurality of devices that operate as a system to generate and/or output content.

The content server 120 may comprise a recording agent, a transcoder, a segment packetizer, and/or a manifest generator, each of which may correspond to hardware, software (e.g., instructions executable by one or more processors of the content server 120), or a combination thereof. The transcoder may perform bitrate conversion, coder/decoder (CODEC) conversion, frame size conversion, etc. For example, the content server 120 may receive source content (e.g., one or more content items, such as movies, television shows, sporting events, news shows, etc.) and the transcoder may transcode the source content to generate one or more transcoded content items. The source content may be a live stream of content (e.g., a linear content stream) or video-on-demand (VOD) content. The content source 120 may receive the source content from an external source (e.g., a stream capture source, a data storage device, a media server, etc.) via a wired or wireless network connection, such as the network 121 or another network (not shown).

The recording agent may instruct the transcoder to generate the one or more transcoded content for one or more recording sessions/content recordings. The recording agent may cause the transcoded content items, as well as associated metadata that identifies each portion of the corresponding content items, to be stored by the segment packetizer. For example, the segment packetizer may comprise a storage medium. The storage medium may store the transcoded content items of the content items (e.g., recorded content items) and/or portions of content items, such as segments, fragments, video/audio files, a combination thereof, and/or the like. For example, the recording agent may cause each portion of the corresponding content items and/or the metadata that identifies each portion of the corresponding content items to be stored in the storage medium.

Each of the transcoded content items may correspond to a plurality of adaptive bitrate (ABR) representations of the source content. For example, the transcoded content items may differ from each other with respect to audio bitrate, a number of audio channels, an audio CODEC, a video bitrate, a video frame size, a video CODEC, a combination thereof, and/or the like.

The segment packetizer may comprise a segmenter. The segmenter may divide a set of ABR representations (e.g., the transcoded content items) into media segments. If the transcoded content items include separate video and audio content, the segmenter may generate the segments such that the video and audio content are timecode aligned.

The manifest generator may generate one or more manifests (e.g., manifest files) based on segment information received from the segment packetizer. The manifest generator may generate one or more manifests based on a manifest type and/or a content segmentation type. The manifest may identify one or more segments of one or more adaptive streaming representations of the source content. The manifest generator may generate manifests based on the segment information from the segment packetizer, including information associated with the segment(s) of the adaptive bitrate representation(s) generated by the transcoder.

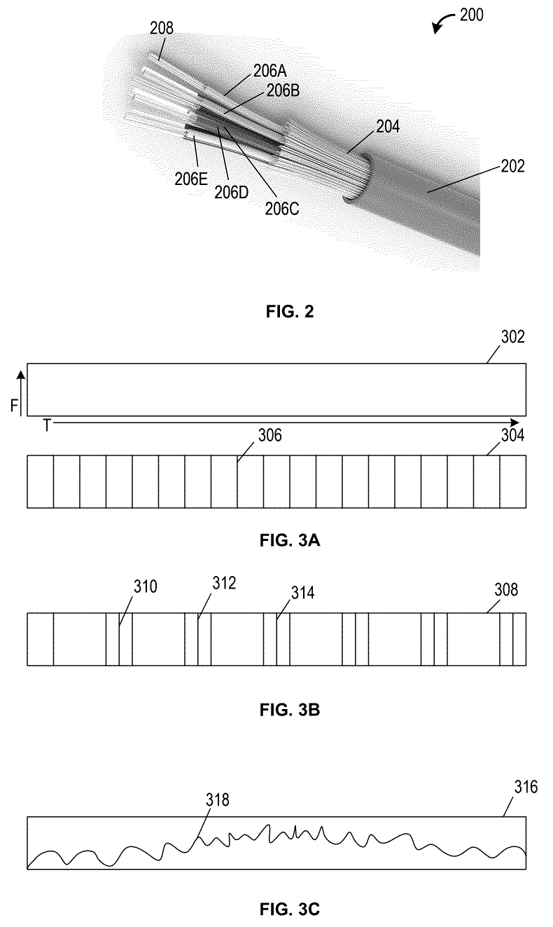

FIG. 2 shows a perspective view of a transmission cable or line 200. For example, the transmission cable or line 200 may be a fiber-optic cable or another form of cable or transmission line. While the example of FIG. 2 describes the transmission cable or line as a fiber-optic cable, this is for example purposes only, as the concepts described with reference to FIG. 2 may be incorporated into and used with other forms of transmission cable or line. The cable 200 may comprise an outer cable jacket 202 that extends around the perimeter of the remainder of the cable 200. The cable 200 may comprise one or more strengthening fibers 204 to support and protect the fibers within the cable 200. The cable 200 may comprise one or more fiber bundles 206A-E disposed within the cable jacket 202. Each of the one or more fiber bundles 206A-E may be surrounded by a coating (e.g. a flexible plastic coating). Within the coating is a fiber or bundle of fibers 208. A portion of the bundle of fibers 208 may be configured to be used as a conduit for sending data (e.g., data, communications, and/or content data such as content items) from one location to another. For example another portion of the bundle of fibers 208 and/or one of the fiber bundles 206A-E may be unused or “dark fibers,” such that no data is being transmitted on that other portion of the bundle of fibers 208 or the one of the fiber bundles 206A-E as part of the power, data, communications and/or content data transmission system. The one or more of the unused fibers of the cable 200 may be used as sensing fibers. For example, the sensing fiber or one of the content data carrying fibers may provide data indicative of an event (e.g., event data) to the computing device 102 via the network device 122 and the network 121 or another network. For example, the event data indicative of the event may comprise IoR data for that portion of the fiber along that portion of the cable 200.

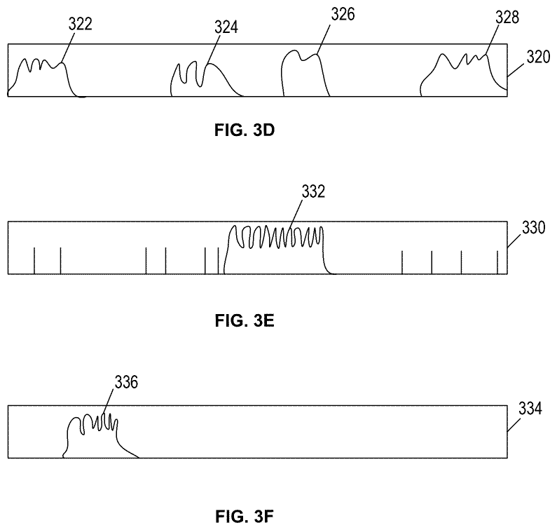

FIGS. 3A-F are examples of IoR data representing forces imparted on a transmission cable or line (e.g., a sensing fiber or one of the content data carrying fibers of the cable), such as any one of the transmission cables or lines 123-134 of FIG. 1. For example, the transmission cable or line may be a fiber-optic cable. While the example of FIGS. 3A-F describes the transmission cable or line as a fiber-optic cable, this is for example purposes only, as the concepts described with reference to FIGS. 3A-F may be incorporated into and used with other forms of transmission cable or line. For example, IoR data may be used to detect and characterize physical changes, such as receiving a force, motion, strain, vibration in the sensing fiber or one of the content data carrying fibers of the cable. These physical changes can be caused by forces, such as pressure and sound waves. Changes in the IoR data of the sensing fiber or one of the content data carrying fibers of the fiber-optic cable may be detected, represented by an “accordion effect,” where the IoR of the sensing fiber or one of the content data carrying fibers may expand or compress with changes in magnitude. As shown in FIG. 3A, the magnitude of the change in IoR (F), that makes up the IoR data, is represented along the vertical axis and time or periodicity (T) is represented along the horizontal axis. For example, the lines 306 of the IoR data 304 represent a steady state of magnitude of change of IoR for a period of time for the IoR data indicated on a sensing fiber or one of the content data carrying fibers of the cable.

FIG. 3B represents IoR data 308 from a sensing fiber or one of the content data carrying fibers of a cable buried in soil. The IoR data 308 shows repetitive sets 310, 312, 314 of the magnitude of change of the IoR for the sensing fiber or one of the content data carrying fibers. These repetitive sets of change have substantially the same magnitude of change in the IoR and are separated in time by a substantially consistent amount of time. For example, the IoR data 308 may be representative of an event for a fiber of a cable extending through soil detecting the user of a jackhammer. The repetitive on/off use in short bursts of the jackhammer on a surface may cause the IoR data 308 shown. The IoR data 308 may be stored in the historical data 106 of the computing device 102 and may be used by the machine-learning system as an event model representing jackhammer use being detected by a cable extending within the soil medium.

FIG. 3C represents IoR data 316 from a sensing fiber or content data carrying fiber of a cable extending through the air (e.g., distributed through the data, power, communications and/or content data transmission system on poles). The IoR data 316 shows the magnitude of change of the IoR 318 for the fiber of the cable as being lower initially and spread out more over time, representing less movement or force applied to the cable. The magnitude of change of the IoR 318 increases and is more time compressed in the middle of the IoR data 316. The magnitude of change of the IoR 318 reduces and gets more spread out over time at the end (right side) of the IoR data 316. For example, the IoR data 318 may be representative of an event for a fiber of a cable disposed in the air detecting a truck passing by on a roadway. As the truck approaches the portion of the cable, the sonic wave it generates builds but is less intense and occurs less frequently. As the truck passes by the portion of the cable, the sonic wave increases and occurs more frequently, imparting more force on the cable and causing a greater magnitude of change in the IoR at a more frequent rate. As the truck drives away from the portion of the cable, the sonic wave decreases and affects the cable less often. As such, a truck passing by a cable extending in the air may cause the IoR data 316 shown. The IoR data 316 may be stored in the historical data 106 of the computing device 102 and may be used by the machine-learning system as an event model representing a truck driving by a cable extending through the air medium.

FIG. 3D represents IoR data 320 from a sensing fiber or a content data carrying fiber of a cable extending through the air. The IoR data 320 shows the magnitude of change of the IoR 322-328 for the fiber of the cable as occurring randomly over time and having variable levels of both length of time and magnitude of change of the IoR for the fiber of the cable. The variability of when the magnitude of change of the IoR 322-328 occurs as well as the magnitude and length of time the change of IoR occurs may represent wind applying a force on and causing movement of the cable extending through the air. As such, wind impacting the cable extending in the air may cause the IoR data 320 shown. The IoR data 320 may be stored in the historical data 106 of the computing device 102 and may be used by the machine-learning system as an event model representing wind blowing a cable extending through the air medium.

FIG. 3E represents IoR data 330 from a sensing fiber or a content data carrying fiber of a cable extending through the air. The IoR data 330 shows the magnitude of change of the IoR 332 for the fiber of the cable as occurring at a significant level over a short period of time with other magnitudes of change of the IoR occurring sparingly and at varying intervals. The timing and level of the magnitude of change of the IoR 332 may represent ice accumulation causing a force on the cable extending through the air. As such, ice accumulation on the cable extending in the air may cause the IoR data 330 shown. The IoR data 330 may be stored in the historical data 106 of the computing device 102 and may be used by the machine-learning system as an event model representing wind blowing a cable extending through the air medium.

FIG. 3F represents IoR data 334 from a sensing fiber or a content data carrying fiber of a cable extending through the air. The IoR data 334 shows the magnitude of change of the IoR 336 for the fiber of the cable as occurring briefly but at a significant level of magnitude for the fiber of the cable. The significant magnitude as well as the short duration and single occurrence for a cable in the air may represent an animal (such as a squirrel) chewing on the cable extending through the air. As such, an animal chewing on the cable extending in the air may cause the IoR data 334 shown. The IoR data 334 may be stored in the historical data 106 of the computing device 102 and may be used by the machine-learning system as an event model representing an animal chewing on the cable extending through the air medium.

While a few examples of event models are provided in FIGS. 3A-F, these are for example only, as a great number of additional models for transmission cables or lines extending through air and other mediums (e.g., water, soil, concrete, asphalt) may also be determined based on historical data for the transmission cables or lines and/or laboratory generated data and may be provided for use by the machine-learning system as an event model representing a particular event for a transmission cable or line laid in or extending through a particular medium.

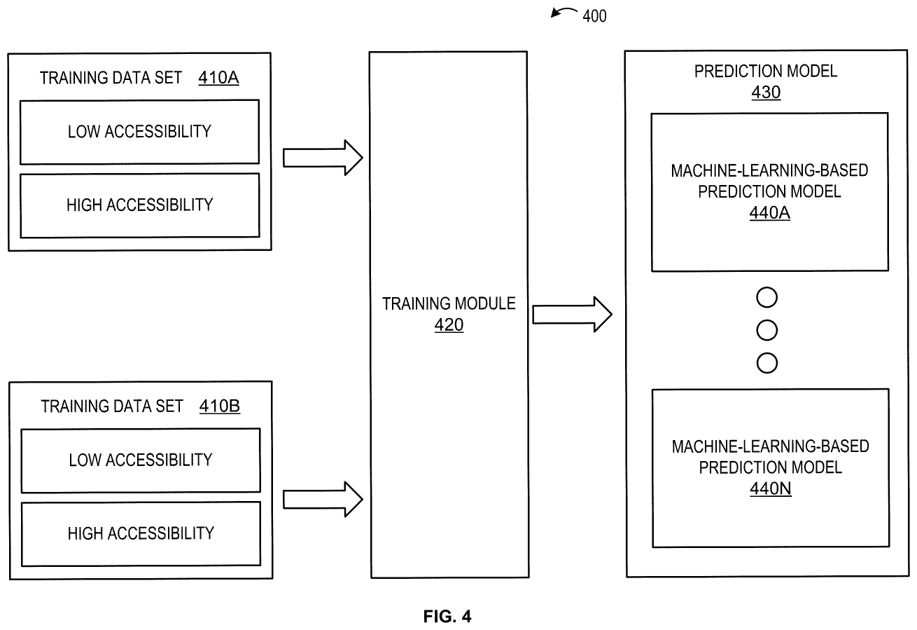

Machine-learning and other artificial intelligence techniques may be used to train a prediction model. The prediction model, once trained, may be configured to determine or identify the type of event that is causing the event data on a portion of a transmission cable or line, the severity of the event with regard to causing damage to the transmission cable or line, and/or the probability that the event (if it continues) will cause a negative impact (e.g., damage the transmission cable or line, disrupt or increase noise in data transmission along the transmission cable or line, sever the transmission cable or line). For example, the computing device 102 of the system 100 may use the trained prediction model to determine or identify the type of event that is causing the event data on a portion of a transmission cable or line, the severity of the event with regard to causing damage to the transmission cable or line, and/or the probability that the event (if it continues) will cause a negative impact (e.g., damage the transmission cable or line, disrupt or increase noise in data transmission along the transmission cable or line, sever the transmission cable or line) on the portion of the table at or proximate to where the event data is being received from. The prediction model (referred to herein as the at least one prediction model 430, or simply the prediction model 430) may be trained by a system 400 as shown in FIG. 4. The system 400 may be part of the computing device 102 or a one or more other separate computing devices configured to provide the prediction model 430 to the computing device 102, via the network 121 or another network, for analysis of event data (e.g., the IoR data or the IQ error-vector data).

The system 400 may be configured to use machine-learning techniques to train, based on an analysis of one or more training datasets 410A-410B by a training module 420, the at least one prediction model 430. The at least one prediction model 430, once trained, may be configured to determine or identify the type of event that is causing the event data on a portion of a transmission cable or line, the severity of the event with regard to causing damage to the transmission cable or line, and/or the probability that the event (if it continues) will cause a negative impact (e.g., damage the transmission cable or line, disrupt or increase noise in data transmission along the transmission cable or line, sever the transmission cable or line). A dataset may be determined or derived from one or more portions of the historical data 106. For example, previous or historical events and the generated IoR data and/or laboratory created IoR data for each medium that the transmission cables or lines pass through and models of impact (e.g., patters of backscatter variability over time and frequency) caused to the particular transmission cable or line based on the event may be used by the training module 420 to train the at least one prediction model 430. For example, previous or historical events and the generated matrix data from the generated IQ error-vector data from the transmission cables or lines or matrix data from laboratory created events causing IQ error-vector data on transmission cables or lines for each medium that the transmission cable or line passes through and models of impact caused to the particular transmission cable or line based on the event may be used by the training module 420 to train the at least one prediction model 430. Each of the historical event data (either historical IoR data or historical IQ error-vector data) and/or laboratory created event data (either IoR data or IQ error-vector data) in the dataset may be associated with one or more multimodal features of a plurality of multimodal features that are associated with the identity of an event in a particular medium, the severity of the event with regard to causing damage to the transmission cable or line, and/or the probability that the event (if it continues) will cause a negative impact (e.g., damage the transmission cable or line, disrupt or increase noise in data transmission along the transmission cable or line, sever the transmission cable or line). The plurality of multimodal features and the event models for each of the events in each of the particular mediums that the transmission cable or line may be extending through, the historical event data, and/or the laboratory created event data may be used to train the at least one prediction model 430.

The training dataset 410A may comprise a first portion of the historical event data and/or laboratory created event data in the dataset. Each historical event data record and/or laboratory created event data record may have an associated event, level of severity, and or likelihood of causing impact to the transmission cable or line and one or more labeled multimodal features associated with the historical event data record and/or laboratory created event data record. The training dataset 410B may comprise a second portion of the historical event data and/or laboratory created event data in the dataset. Each historical event data record and/or laboratory created event data record in the second portion may have an associated event, level of severity, and/or likelihood of causing impact to the transmission cable or line and one or more labeled multimodal features associated with the historical event data record and/or laboratory created event data record. The historical event data and/or laboratory created event data may be randomly assigned to the training dataset 410A, the training dataset 410B, and/or to a testing dataset. In some implementations, the assignment of historical event data and/or laboratory created event data to a training dataset or a testing dataset may not be completely random. In this case, one or more criteria may be used during the assignment, such as ensuring that similar numbers of historical event data and/or laboratory created event data items with different events, level of severity, and/or likelihood of causing impact on a transmission cable or line, and/or multimodal features are in each of the training and testing datasets. In general, any suitable method may be used to assign the historical event data and/or laboratory created event data to the training or testing datasets, while ensuring that the distributions of event types, severity levels, and/or likelihoods of causing impact on the transmission cable or line and/or multimodal features are somewhat similar in the training dataset and the testing dataset.

The training module 420 may use the first portion and the second portion of the plurality of historical event data and/or laboratory created event data to determine one or more multimodal features that are indicative of an accurate (e.g., a high confidence level for the) event type for a transmission cable or line in a particular medium, level of severity, and/or likelihood of causing impact on the transmission cable or line. That is, the training module 420 may determine which multimodal features associated with the plurality of historical event data and/or laboratory created event data are correlative with an accurate event type for a transmission cable or line in a particular medium, level of severity, and/or likelihood of causing impact on the transmission cable or line. The one or more multimodal features indicative of an accurate event type for a transmission cable or line in a particular medium, level of severity, and/or likelihood of causing impact on the transmission cable or line may be used by the training module 420 to train the prediction model 430. For example, the training module 420 may train the prediction model 430 by extracting a feature set (e.g., one or more multimodal features) from the first portion in the training dataset 410A according to one or more feature selection techniques. The training module 420 may further define the feature set obtained from the training dataset 410A by applying one or more feature selection techniques to the second portion in the training dataset 410B that includes statistically significant features of positive examples (e.g., accurate event type for a transmission cable or line in a particular medium, level of severity, and/or likelihood of causing impact on the transmission cable or line) and statistically significant features of negative examples (e.g., inaccurate event type for a transmission cable or line in a particular medium, level of severity, and/or likelihood of causing impact on the transmission cable or line). The training module 420 may train the prediction model 430 by extracting a feature set from the training dataset 410B that includes statistically significant features of positive examples (e.g., accurate event type for a transmission cable or line in a particular medium, level of severity, and/or likelihood of causing impact on the transmission cable or line) and statistically significant features of negative examples (e.g., inaccurate event type for a transmission cable or line in a particular medium, level of severity, and/or likelihood of causing impact on the transmission cable or line).

The training module 420 may extract a feature set from the training dataset 410A and/or the training dataset 410B in a variety of ways. For example, the training module 420 may extract a feature set from the training dataset 410A and/or the training dataset 410B using a multimodal detector. The training module 420 may perform feature extraction multiple times, each time using a different feature-extraction technique. In one example, the feature sets generated using the different techniques may each be used to generate different machine-learning-based prediction models 440. For example, the feature set with the highest quality metrics may be selected for use in training. The training module 420 may use the feature set(s) to build one or more machine-learning-based prediction models 440A-440N that are configured to provide an event type for a transmission cable or line in a particular medium, level of severity, and/or likelihood of causing impact on the transmission cable or line for a historical event data record and/or laboratory created event data record.

The training dataset 410A and/or the training dataset 410B may be analyzed to determine any dependencies, associations, and/or correlations between multimodal features and the predetermined event types for a transmission cable or line in a particular medium, levels of severity, and/or likelihoods of causing impact on the transmission cable or line in the training dataset 410A and/or the training dataset 410B. The identified correlations may have the form of a list of multimodal features that are associated with different event types for a transmission cable or line in a particular medium, levels of severity, and/or likelihoods of causing impact on the transmission cable or line. The multimodal features may be considered as features (or variables) in the machine-learning context. The term “feature,” as used herein, may refer to any characteristic of an item of data that may be used to determine whether the item of data falls within one or more specific categories or within a range. By way of example, the features described herein may comprise one or more multimodal features.

A feature selection technique may comprise one or more feature selection rules. The one or more feature selection rules may comprise a multimodal feature occurrence rule. The multimodal feature occurrence rule may comprise determining which multimodal features in the training dataset 410A occur over a threshold number of times and identifying those multimodal features that satisfy the threshold as candidate features. For example, any multimodal features that appear greater than or equal to 5 times in the training dataset 410A may be considered as candidate features. Any multimodal features appearing less than 5 times may be excluded from consideration as a feature. Other threshold numbers may be used in the place of the example 5 times presented above.

A single feature selection rule may be applied to select features or multiple feature selection rules may be applied to select features. The feature selection rules may be applied in a cascading fashion, with the feature selection rules being applied in a specific order and applied to the results of the previous rule. For example, the multimodal feature occurrence rule may be applied to the training dataset 410A to generate a first list of multimodal features. A final list of candidate multimodal features may be analyzed according to additional feature selection techniques to determine one or more candidate multimodal feature groups (e.g., groups of multimodal features that may be used to predict an event type for a transmission cable or line in a particular medium, level of severity, and/or likelihood of causing impact on the transmission cable or line). Any suitable computational technique may be used to identify the candidate multimodal feature groups using any feature selection technique such as filter, wrapper, and/or embedded methods. One or more candidate multimodal feature groups may be selected according to a filter method. Filter methods include, for example, Pearson's correlation, linear discriminant analysis, analysis of variance (ANOVA), chi-square, combinations thereof, and the like. The selection of features according to filter methods are independent of any machine-learning algorithms used by the system 400. Instead, features may be selected on the basis of scores in various statistical tests for their correlation with the outcome variable (e.g., a predicted viewing window).

As another example, one or more candidate multimodal feature groups may be selected according to a wrapper method. A wrapper method may be configured to use a subset of features and train the prediction model 430 using the subset of features. Based on the inferences that drawn from a previous model, features may be added and/or deleted from the subset. Wrapper methods include, for example, forward feature selection, backward feature elimination, recursive feature elimination, combinations thereof, and the like. For example, forward feature selection may be used to identify one or more candidate multimodal feature groups. Forward feature selection is an iterative method that begins with no features. In each iteration, the feature which best improves the model is added until an addition of a new variable does not improve the performance of the model. As another example, backward elimination may be used to identify one or more candidate multimodal feature groups. Backward elimination is an iterative method that begins with all features in the model. In each iteration, the least significant feature is removed until no improvement is observed on removal of features. Recursive feature elimination may be used to identify one or more candidate multimodal feature groups. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

As a further example, one or more candidate multimodal feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to absolute value of the magnitude of coefficients and ridge regression performs L2 regularization which adds a penalty equivalent to square of the magnitude of coefficients.

After the training module 420 has generated a feature set(s), the training module 420 may generate the one or more machine-learning-based prediction models 440A-440N based on the feature set(s). A machine-learning-based prediction model (e.g., any of the one or more machine-learning-based prediction models 440A-440N) may refer to a complex mathematical model for data classification that is generated using machine-learning techniques as described herein. In one example, a machine-learning-based prediction model may include a map of support vectors that represent boundary features. By way of example, boundary features may be selected from, and/or represent the highest-ranked features in, a feature set.

The training module 420 may use the feature sets extracted from the training dataset 410A and/or the training dataset 410B to build the one or more machine-learning-based prediction models 440A-440N for each classification category (e.g., event types for a transmission cable or line in a particular medium, levels of severity, and/or likelihoods of causing impact on the transmission cable or line). In some examples, the one or more machine-learning-based prediction models 440A-440N may be combined into a single machine-learning-based prediction model 440 (e.g., an ensemble model). Similarly, the prediction model 430 may represent a single classifier containing a single or a plurality of machine-learning-based prediction models 440 and/or multiple classifiers containing a single or a plurality of machine-learning-based prediction models 440 (e.g., an ensemble classifier).

The extracted features (e.g., one or more candidate multimodal features) may be combined in the one or more machine-learning-based prediction models 440A-440N that are trained using a machine-learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting prediction model 430 may comprise a decision rule or a mapping for each candidate multimodal feature in order to assign a predicted event type for a transmission cable or line in a particular medium, level of severity, and/or likelihood of causing impact on the transmission cable or line to a class (e.g., event types, ranges of level of severity, and/or ranges of likelihood of causing impact on the transmission cable or line). As described further herein, the resulting prediction model 430 may be used to provide a predicted event type for a transmission cable or line in a particular medium, level of severity, and/or likelihood of causing impact on the transmission cable or line for when event data (e.g., IoR data or IQ error-vector data) is received from a transmission cable or line that is part of the data, power, communication or content data transmission system. The candidate multimodal features and the prediction model 430 may be used to predict event types for a transmission cable or line in a particular medium, level of severity, and/or likelihood of causing impact on the transmission cable or line for received event data (e.g., IoR data records and/or IQ error-vector data records in the testing dataset (e.g., a third portion of the plurality of historical event data and/or laboratory created event data).

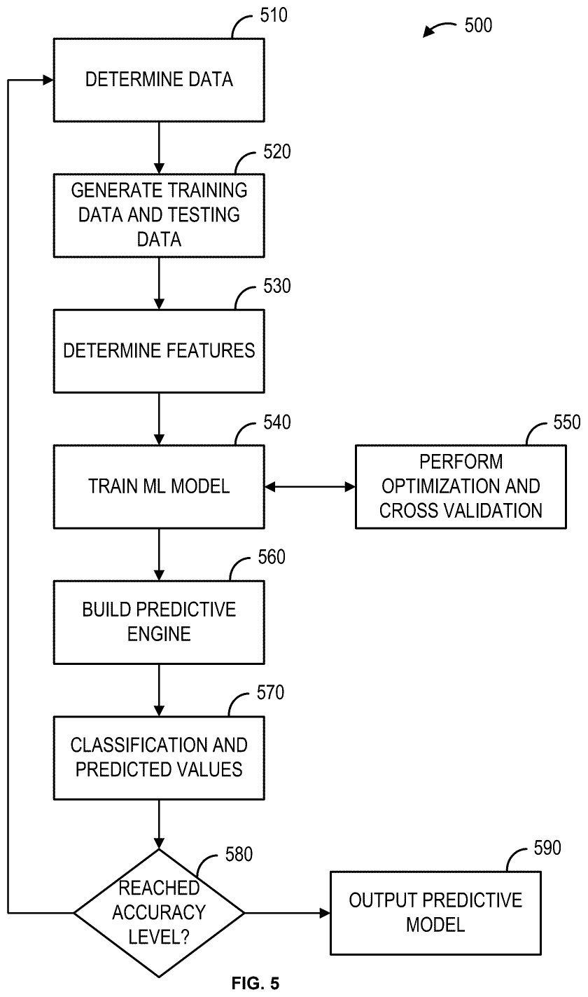

FIG. 5 is a flowchart illustrating an example training method 500 for generating the prediction model 430 using the training module 420. The training module 420 can implement supervised, unsupervised, and/or semi-supervised (e.g., reinforcement based) machine-learning-based prediction models 440A-440N. The method 500 illustrated in FIG. 5 is an example of a supervised learning method; variations of this example of training method are discussed below, however, other training methods can be analogously implemented to train unsupervised and/or semi-supervised machine-learning models. The method 500 may be implemented by the computing devices 102 or by another computing device, such as a separate machine-learning computing system.

At 510, the training method 500 may determine (e.g., access, receive, retrieve, etc.) first historical event data and/or laboratory created event data (e.g., the first portion of the plurality of historical event data records and/or laboratory created event data records described above) and second historical event data and/or laboratory created event data (e.g., the second portion of the plurality of historical event data records and/or laboratory created event data records described above). The first historical event data and/or laboratory created event data and the second historical event data and/or laboratory created event data may each comprise one or more multimodal features and a predetermined event type for a transmission cable or line in a particular medium, level of severity, and/or likelihood of causing impact on the transmission cable or line. The training method 500 may generate, at 520, a training dataset and a testing dataset. The training dataset and the testing dataset may be generated by randomly assigning historical event data records and/or laboratory created event data records from the first historical event data and/or laboratory created event data and/or the second historical event data and/or laboratory created event data to either the training dataset or the testing dataset. In some implementations, the assignment of historical event data and/or laboratory created event data as training or test samples may not be completely random. As an example, only the historical event data and/or laboratory created event data for a specific multimodal feature(s) and/or type(s) of event for a transmission cable or line in a particular medium, range(s) of level of severity, and/or range(s) of likelihood of causing impact on the transmission cable or line may be used to generate the training dataset and the testing dataset. As another example, a majority of the historical event data and/or laboratory created event data for the specific multimodal feature(s) and/or type(s) of event for a transmission cable or line in a particular medium, range(s) of level of severity, and/or range(s) of likelihood of causing impact on the transmission cable or line may be used to generate the training dataset. For example, 75% of the historical event data and/or laboratory created event data for the specific multimodal feature(s) and/or type(s) of event for a transmission cable or line in a particular medium, range(s) of level of severity, and/or range(s) of likelihood of causing impact on the transmission cable or line may be used to generate the training dataset and 25% may be used to generate the testing dataset.

The training method 500 may determine (e.g., extract, select, etc.), at 530, one or more features that can be used by, for example, a classifier to differentiate among different classifications (e.g., event types for a transmission cable or line in a particular medium, levels of severity, and/or likelihoods of causing impact on the transmission cable or line). The one or more features may comprise a set of multimodal features. As an example, the training method 500 may determine a set features from the first historical event data and/or laboratory created event data. As another example, the training method 500 may determine a set of features from the second historical event data and/or laboratory created event data. In a further example, a set of features may be determined from other historical event data and/or laboratory created event data of the plurality of historical event data and/or laboratory created event data (e.g., a third portion) associated with a specific multimodal feature(s) and/or type(s) of event for a transmission cable or line in a particular medium, range(s) of level of severity, and/or range(s) of likelihood of causing impact on the transmission cable or line associated with the historical event data and/or laboratory created event data of the training dataset and the testing dataset. In other words, the other historical event data and/or laboratory created event data (e.g., the third portion) may be used for feature determination/selection, rather than for training. The training dataset may be used in conjunction with the other historical event data and/or laboratory created event data to determine the one or more features. The other historical event data and/or laboratory created event data may be used to determine an initial set of features, which may be further reduced using the training dataset.

The training method 500 may train one or more machine-learning models (e.g., one or more prediction models) using the one or more features at 540. In one example, the machine-learning models may be trained using supervised learning. In another example, other machine-learning techniques may be employed, including unsupervised learning and semi-supervised. The machine-learning models trained at 540 may be selected based on different criteria depending on the problem to be solved and/or data available in the training dataset. For example, machine-learning models can suffer from different degrees of bias. Accordingly, more than one machine-learning model can be trained at 540, and then optimized, improved, and cross-validated at 550.

The training method 500 may select one or more machine-learning models to build the prediction model 430 at 560. The prediction model 430 may be evaluated using the testing dataset. The prediction model 430 may analyze the testing dataset and generate classification values and/or predicted values (e.g., event types for a transmission cable or line in a particular medium, levels of severity, and/or likelihoods of causing impact on the transmission cable or line) at 570. Classification and/or prediction values may be evaluated at 580 to determine whether such values have achieved a desired accuracy level (e.g., a confidence level for the predicted event type for a transmission cable or line in a particular medium, level of severity, and/or likelihood of causing impact on the transmission cable or line). Performance of the prediction model 430 may be evaluated in a number of ways based on a number of true positives, false positives, true negatives, and/or false negatives classifications of the plurality of data points indicated by the prediction model 430.

For example, the false positives of the prediction model 430 may refer to a number of times the prediction model 430 incorrectly assigned an accurate event type for a transmission cable or line in a particular medium, level of severity, and/or likelihood of causing impact on the transmission cable or line to a historical event data record and/or laboratory created event data record associated with a low confidence level. Conversely, the false negatives of the prediction model 430 may refer to a number of times the machine-learning model assigned an inaccurate event type for a transmission cable or line in a particular medium, level of severity, and/or likelihood of causing impact on the transmission cable or line to a historical event data record and/or laboratory created event data record associated with a high confidence level. True negatives and true positives may refer to a number of times the prediction model 330 correctly assigned event types for a transmission cable or line in a particular medium, levels of severity, and/or likelihoods of causing impact on the transmission cable or line to a historical event data record and/or laboratory created event data record based on the known, predetermined event types for a transmission cable or line in a particular medium, levels of severity, and/or likelihoods of causing impact on the transmission cable or line, for each historical event data record and/or laboratory created event data record. Related to these measurements are the concepts of recall and precision. Generally, recall refers to a ratio of true positives to a sum of true positives and false negatives, which quantifies a sensitivity of the prediction model 430. Similarly, precision refers to a ratio of true positives a sum of true and false positives. When such a desired accuracy level (e.g., confidence level) is reached, the training phase ends and the prediction model 430 may be output at 590; when the desired accuracy level is not reached, however, then a subsequent iteration of the training method 500 may be performed starting at 510 with variations such as, for example, considering a larger collection of historical event data records and/or laboratory created event data records.

The prediction model 430 may be output at 590. The prediction model 430 may be configured to provide predicted event types for a transmission cable or line in a particular medium, levels of severity, and/or likelihoods of causing impact on the transmission cable or line for event data records (e.g., IoR data or IQ error-vector data) that are not within the plurality of historical event data and/or laboratory created event data used to train the prediction model. For example, the prediction model 430 may be trained and output by a first computing device. The first computing device may provide the prediction model 430 to a second computing device, such as the computing device 102. As described herein, the method 500 may be implemented by the computing device 102 or another computing device.

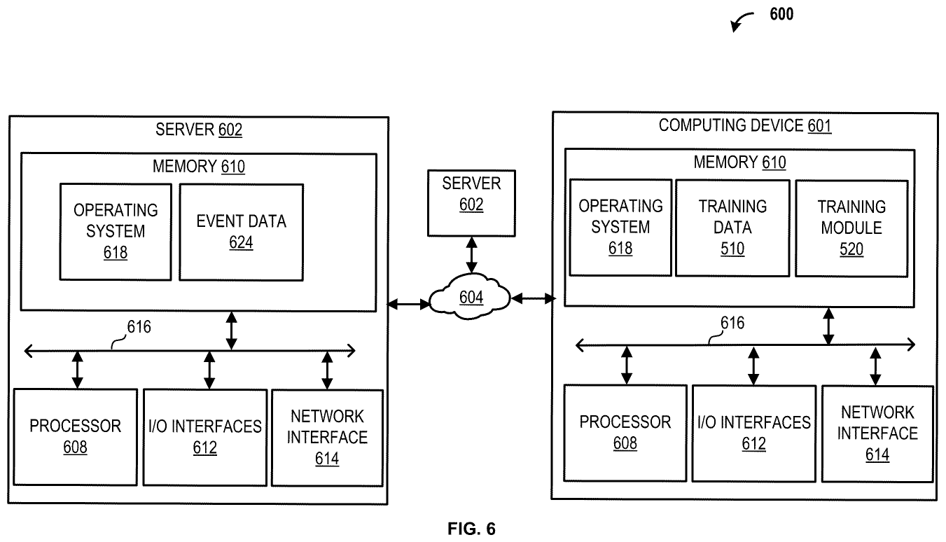

As discussed herein, the present methods and systems may be computer-implemented. FIG. 6 shows a block diagram depicting an environment 600 comprising non-limiting examples of a computing device 601 and a server 602 connected through a network 604, such as the network 121. The computing device 601 and/or the server 602 may be any one of the computing device 102 or the content server 120 of FIG. 1. In an aspect, some or all steps of any described method herein may be performed on a computing device as described herein. The computing device 601 can comprise one or multiple computers configured to store one or more of the training module 620, training data 610, and the like. The server 602 can comprise one or multiple computers configured to store, send, and/or transmit power, data, communications, and/or content data (e.g., a plurality of content items). Multiple servers 602 can communicate with the computing device 601 via the through the network 604.

The computing device 601 and the server 602 may each be a digital computer that, in terms of hardware architecture, generally includes a one or more processors 608, memory system 610, input/output (I/O) interfaces 612, and network interfaces 614. These components (608, 610, 612, and 614) are communicatively coupled via a local interface 616. The local interface 616 can be, for example, but not limited to, one or more buses or other wired or wireless connections, as is known in the art. The local interface 616 can have additional elements, which are omitted for simplicity, such as controllers, buffers (caches), drivers, repeaters, and receivers, to enable communications. Further, the local interface may include address, control, and/or data connections to enable appropriate communications among the aforementioned components.

The one or more processors 608 can be hardware device(s) for executing software, particularly that stored in memory system 610. The one or more processors 608 can be any custom made or commercially available processor, a central processing unit (CPU), an auxiliary processor among several processors associated with the computing device 601 and the server 602, a semiconductor-based microprocessor (in the form of a microchip or chip set), or generally any device for executing software instructions. When the computing device 601 and/or the server 602 is in operation, the one or more processors 608 can be configured to execute software stored within the memory system 610, to communicate data to and from the memory system 610, and to generally control operations of the computing device 601 and the server 602 pursuant to the software.

The I/O interfaces 612 can be used to receive user input from, and/or for providing system output to, one or more devices or components. User input can be provided via, for example, a keyboard and/or a mouse. System output can be provided via a display device and a printer (not shown). I/O interfaces 612 can include, for example, a serial port, a parallel port, a Small Computer System Interface (SCSI), an infrared (IR) interface, a radio frequency (RF) interface, and/or a universal serial bus (USB) interface.

The network interface 614 can be used to transmit and receive from the computing device 601 and/or the server 602 on the network 604. The network interface 614 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi, cellular, satellite), or any other suitable network interface device. The network interface 614 may include address, control, and/or data connections to enable appropriate communications on the network 604.

The memory system 610 can include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 610 may incorporate electronic, magnetic, optical, and/or other types of storage media. Note that the memory system 610 can have a distributed architecture, where various components are situated remote from one another, but can be accessed by the one or more processors 608.

The software in memory system 610 may include one or more software programs, each of which comprises an ordered listing of executable instructions for implementing logical functions associated with the one or more methods described herein. In the example of FIG. 6, the software in the memory system 610 of the computing device 601 can comprise the training module 620 (or subcomponents thereof), the training data 610, and a suitable operating system (O/S) 618. In the example of FIG. 6, the software in the memory system 610 of the server 602 can comprise, the historical event data and/or laboratory created event data 624, and a suitable operating system (O/S) 618. The operating system 618 essentially controls the execution of other computer programs and provides scheduling, input-output control, file and data management, memory management, and communication control and related services.

For purposes of illustration, application programs and other executable program components such as the operating system 618 are illustrated herein as discrete blocks, although it is recognized that such programs and components can reside at various times in different storage components of the computing device 601 and/or the server 602. An implementation of the training module 620 can be stored on or transmitted across some form of computer-readable media. Any of the disclosed methods can be performed by computer-readable instructions embodied on computer-readable media (e.g., non-transitory computer-readable media). Computer-readable media can be any available media that can be accessed by a computer. By way of example and not meant to be limiting, computer-readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

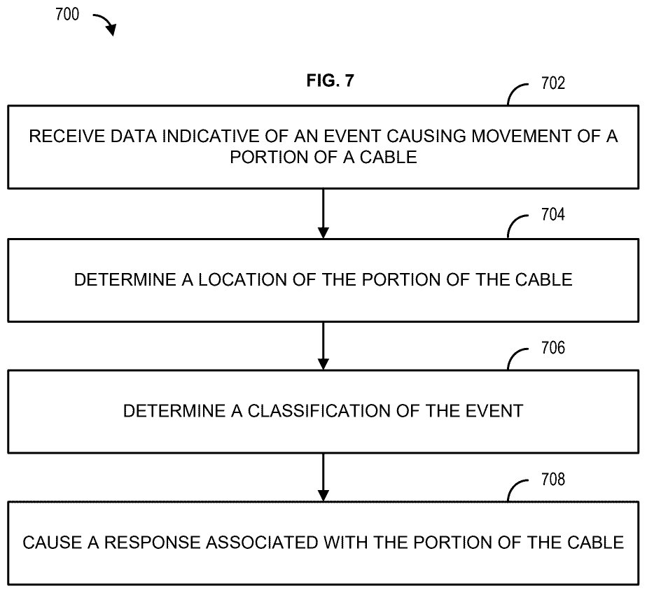

FIG. 7 shows a flowchart of an example method 700 for determining the potential for damage to a transmission cable or line caused by an event. The methods described in FIG. 7 may be completed by a computing device, such as the computing device 102 or any other computing device described herein. While the method 700 of FIG. 7 will be described as being completed by the computing device 102 this is for example purposes only.

At 702, event data indicative of an event may be received from a transmission cable or line. For example, the event data may be received by the computing device 102. For example, the computing device 102 may receive the event data from a network device, such as network device 122 communicably coupled, either directly or indirectly, to the transmission cable or line. For example, the event data may be received by the monitoring system 103 of the computing device 102. For example, the event data may be received from a portion of a transmission cable or line, such as a segment or length of transmission cable or line at a particular location. For example, the transmission cable or line may be one of a wire, power line, coaxial cable, other transmission line, or a fiber-optic cable. For example, the transmission cable or line may be part of the power, data, communication, and/or content data transmission system. For example, the event data may comprise one or more of IoR data associated with the portion of the transmission cable or line or IQ error-vector data associated with the portion of the transmission cable or line. For example, the IoR data or the IQ error-vector data may be detected within that portion of the transmission cable or line at the location. For example, the event data (e.g., the IoR data and/or the IQ error-vector data) may comprise one or more of an indication of a force applied to the portion of the transmission cable or line, an indication of a magnitude of the force applied to the portion of the transmission cable or line, or a duration of the force applied to the portion of the transmission cable or line.

For example, the transmission cable or line may be a fiber-optic cable, wherein portions of the fiber-optic cable (e.g., a plurality of glass fibers) are used for transmission of data communications, and/or content data (e.g., content data carrying fibers), and another portion of the fiber-optic cable (e.g., one or more glass fibers, dark fibers, unused fibers or sensing fibers) may not be in use for transmission of data, communications, and/or content data and could optionally be used as a sensing fiber. For example, one or both of the sensing fiber and the content data carrying fiber may be used to sense for events along the length of the transmission cable or line to provide feedback to the computing device 102.

For example, the forces caused by the event (e.g., the truck running along the road) may cause a deflection in the sensing fiber or one of the content data carrying fibers that causes a change in the index of refraction for that portion of the fiber of that portion of the transmission cable or line. As a result of the force on the sensing fiber or one of the content data carrying fibers, the index of refraction of the sensing fiber or one of the content data carrying fibers may expand and/or compress based on the changes in magnitude of the force applied to the sensing fiber or one of the content data carrying fibers. These changes in the index of refraction may be, via the transmission cable or line, sent to, determined by, or detected by the computing device 102 via the network 121 in the form of index of refraction (IoR) data. The computing device 102 may receive the IoR data (e.g., these changes and magnitudes of the index of refraction as a function of time). The IoR data may also include a location of the portion of the transmission cable or line wherein the sensing fiber or one of the content data carrying fibers indicated the particular changes in the index of refraction.

For example, the transmission cable or line may be a wire, power line, fiber-optic cable, other transmission line, or a coaxial cable. For example, one or more portions of the transmission cable or line may be used or configured to be used as a sensor that can sense events (e.g., soundwaves, shockwaves, vibration, motion, etc.) and provide feedback to the computing device 102. For example, the generated forces of an event may cause one or more portions of the transmission cable or line to vibrate. The vibration of the one or more portions of the transmission cable or line changes the physical properties of that portion of the transmission cable or line, including the amount of Rayleigh scattering, for fiber-optic cables, or impedance levels that occur along that portion of the transmission cable or line. The variations over time in Rayleigh scattering or impedance levels along the portion of the transmission cable or line cause changes over time in the IQ error-vector of the code words transmitted along the transmission cable or line. The changes in Rayleigh scattering or impedance levels resulting in changes to the IQ error-vector for each frame for each subcarrier in orthogonal frequency-division multiple access (OFDMA), caused by the event and detected by the sensor in each portion of the transmission cable or line may be, via the transmission cable or line, sent to, determined by, or detected by the computing device 102 via the network 121 in the form of IQ error-vector data. The computing device 102 may receive the Rayleigh scattering data, for fiber-optic cables, or impedance levels, for wires, power lines, other transmission lines, or coaxial cables, continuously or at a sampled rate from the one or more transmission cables or lines and may use that data to determine changes to IQ error-vectors and detect the event. The IoR data or impedance data received from the transmission cable or line may also include a location of the portion of the transmission cable or line that sensed the vibration.

The computing device 102 (e.g., the monitoring system 103) may also receive pre-equalization data from the network device 122. For example, when the network device 122 receives data or messages from an access point, such as access points 150A-B of FIG. 1, the network device 122 may evaluate the data or message to determine if there are linear distortions or impairments that can be reduced by having the access point adjust the access point's signal. When impairments or distortions are detected, the network device 122 sends to the access point one or more equalizer adjustment values, called coefficients, which the access point applies for upstream messages or data sent to the network device 122. The computing device 102 may determine or receive the equalizer adjustment values in the form of pre-equalization data associated with each of the one or more transmission cables or lines in the data, power, communications, and/or content data transmission system from one or more network devices, via the network 121 or another network, and may subsequently use the pre-equalization data with the IQ error-vector data when determining events occurring near one of the transmission cables or lines.

At 704, a location for the portion of the transmission cable or line, from which the event data is received, may be determined. For example, the location for the portion of the transmission cable or line may be determined by a computing device, such as the computing device 102 or any other computing device described herein. For example, the location for the portion of the transmission cable or line may be determined based on the event data received. For example, the received event data may comprise an indicator of the location for the portion of the transmission cable or line. For example, the IoR data may comprise an indicator of the location for the portion of the transmission cable or line. For example, the computing device 102 may evaluate the topology for the data, power, communications, and/or content data transmission system in the location data to determine the location of the portion of the transmission cable or line.

For example, the location may be determined based on the sensor of the transmission cable or line from which the event data was received. For example, determining the location for the portion of the transmission cable or line may be based on the distance between sensors on the transmission cable or line and the particular sensor that sensed the event and provided the event data (e.g., IoR data or IQ error-vector data). For example, the distance between sensors on the transmission cable or line may be based on the number of subcarriers being provided on the transmission cable or line. For example, OFDMA with 45 megahertz (MHZ) width, 25 kilohertz (kHz) subcarrier spacing and 1800 subcarriers would have a time resolution (RT) of 11.1 nanoseconds and a distance resolution of 2.9 meters, as measured by the formula distance resolution (DR)=(RT)*c*VOP, where “c” is the speed of light in a vacuum and “VOP” is the velocity of propogation of the signal in the transmission medium (e.g. transmission cable or line) as compared to the speed of light (e.g., about 0.87 for coaxial cable and about 0.67 for fiber-optic cable). For example, based on the distance resolution, a sensor measure may be made by the transmission cable or line every 2.9 meters of linear length of the transmission cable or line. The actual number of sensors along the transmission cable or line may be less due to a lack of uniformity in impedance mismatches along the transmission cable or line and different in response to events along the transmission cable or line. For example, the IQ error-vector data may be normalized to determine the number of sensors and the distance between each of the sensors for subsequently determining the location of the sensor for the portion of the transmission cable or line from which the event data was received.

For example, determining the location of the portion of the transmission cable or line may comprise determining a medium (e.g., air, water, soil, concrete, asphalt, rock, etc.) in which the portion of the transmission cable or line extends through. For example, the medium for the portion of the transmission cable or line may be associated with the determined location for the portion of the transmission cable or line. For example, the computing device 102 may determine the medium for the portion of the transmission cable or line based on an entry comprising or associated with the determined location for the portion of the transmission cable or line in the location database 107.

For example, the IQ error-vector data may comprise the error-vector for a frame for each subcarrier in OFDMA for the portion of the transmission cable or line based on the occurring event. The computing device 102 (e.g., the event analyzer 110) may apply an inverse fast Fourier transformation to convert the error-vector for each frame from a frequency domain to a time domain and interleave I (e.g., amplitude of the in-phase signal) and Q (e.g., amplitude of the quadrature signal) values to create modified error-vector data. The computing device 102 may normalize the modified error-vector data based on pre-equalization data for the particular transmission cable or line and by summing 1 to N adjacent values, where N can be any number between 2 and 20. For example, summation of the modified error-vector data may increase sensitivity but decrease time or distance resolution. For example, the summing of the modified error-vector data may vary such that different spans of the transmission cable or line may have different values of N (e.g., subcarriers of the signal on the transmission cable or line) depending on normalization and sensitivity for the transmission cable or line. The computing device 102 may determine the sum of 1 to P frames for the summed modified error-vector data. The computing device 102 may compute the delta between each frame, or sum of P frames, to create the matrix data. The resulting matrix data is a matrix with the horizontal rows being the independent sensors and the vertical rows being changes in that particular sensor over time. Frequencies of each sensor (e.g., each vertical column of the matrix) may be determined by fast Fourier transform or audio playback. Distance between each sensor may be determined by the number of values summed and the distance between each sensor. The location of a particular sensor (e.g., latitude and longitude for the sensor) may be calculated using the determined distance and a geographic information system with transmission cable or line locations from the location data 107.

At 706, a classification of an event may be determined. For example, the classification of the event may be a determination of what the event was that caused the event data to occur on the portion of the transmission cable or line at the location. For example, determining the classification of the event may comprise determining one or more of determining the type of the event, determining the severity of the event with regard to causing damage to the portion of the transmission cable or line, or determining the likelihood or the probability that the event (if it continues) will cause a negative impact (e.g., damage the transmission cable or line, disrupt or increase noise in data transmission along the transmission cable or line, sever the transmission cable or line) on the portion of the transmission cable or line. For example, the classification of the event may be determined by a computing device, such as the computing device 102, the machine-learning computing device 601 or any other computing device described herein. For example, the classification of the event may be determined based on a machine-learning model, such as a machine-learning prediction model 108, 430. For example, the classification of the event indicated at the portion of the transmission cable or line may be determined based on one or more of the event data (e.g., the IoR data and/or the IQ error-vector data), the location of the portion of the transmission cable or line, the medium (e.g., air, water, soil, concrete, asphalt, rock, etc.) the portion of the transmission cable or line extends through, or the environment (e.g., the medium and/or location) for the portion of the transmission cable or line.

For example, the IoR data received or detected from a portion of the transmission cable or line may be evaluated by the computing device 102, 601 to determine the magnitude of change of the IoR data over time and plotted along a graph over time. For example, determining the classification of an event may comprise the computing device 102, 601 determining at least one magnitude of change of a force received by the portion of the transmission cable or line. The at least one magnitude of change of a force may be determined based on the IoR data. For example, determining the classification of the event may comprise determining a duration of the magnitude of change the force. The at least one duration of the magnitude of change of the force may be determined by the computing device 102, 601 based on the IoR data. For example, the classification of the event may be determined based on the at least one magnitude of change of the force and the duration of the magnitude of change of the force on the transmission cable or line based on the IoR data.

For example, the computing device 102, 601 may determine the classification of the event occurring near or adjacent the portion of the transmission cable or line by comparing the magnitude of the change of the IoR data over time derived from the IoR data to event models of known patterns of a magnitude of change over time of IoR data caused by known events using the prediction model 108, 430. For example, the computing device 102, 601 may determine the probability that the magnitude of the change of the IoR data over time derived from the IoR data matches each event model of known patterns of magnitude of change of the IoR data over time caused by events. The event models may be further based on the particular medium or environment for the portion of the transmission cable or line. The prediction model 108, 430 may determine the event type based on the event model having the highest probability of matching the magnitude of the change of the IoR data over time derived from the IoR data for the portion of the transmission cable or line.

The computing device 102, 601 may determine the severity (e.g., severity level or range of severity levels) of the event to the portion of the transmission cable or line at that location based on the IoR data. For example, the computing device 102, 601 may determine the severity of the event to the portion of the transmission cable or line by comparing the magnitude of the change of the IoR data over time derived from the IoR data to event models of known patterns of severity to a transmission cable or line for a particular event and for a transmission cable or line within a particular medium or environment (e.g., a particular severity level or range of severity level, such as on a scale of 1-10) using the prediction model 108, 430. For example, the computing device 102, 601 may determine the probability that the magnitude of the change of the IoR data over time for the portion of the transmission cable or line and derived from the IoR data matches each event model of known patterns of magnitude of the change of the IoR data over time for known levels of severity to a transmission cable or line in a particular medium or environment when subjected to a particular event. The event models may be based on the particular medium or environment for the portion of the transmission cable or line. The prediction model 108, 430 may determine the severity level of the event based on the event model of severity levels or ranges having the highest probability of matching the magnitude of the change of the IoR data over time derived from the IoR data for the portion of the transmission cable or line.

The computing device 102, 601 may determine, based on the received IoR data from a portion of a transmission cable or line, the probability or likelihood that the event (if it continues) will cause a negative impact (e.g., damage the transmission cable or line, disrupt or increase noise in data transmission along the transmission cable or line, sever the transmission cable or line) to the portion of the transmission cable or line at that location and the level of impact that will occur. For example, the computing device 102, 601 may determine the probability or likelihood that the event (if it continues) will cause a negative impact and the level of impact by comparing the magnitude of the change of the IoR data over time derived from the IoR data to event models of known patterns of impact caused by events for a transmission cable or line within a particular medium or environment (e.g., a particular likelihood or probability of impact level or range of impact levels, such as on a scale of 1-10) using the prediction model 108, 430. For example, the computing device 102, 601 may determine the probability that the magnitude of the change of the IoR data over time derived from the IoR data matches each event model of known patterns of matrices for known levels of likelihood or probability of impact caused by events for a transmission cable or line within a particular medium or environment and the level or impact when subjected to a particular event. The event models may be based on the particular medium or environment for the portion of the transmission cable or line. The prediction model 108, 430 may determine the likelihood or probability level of an impact on the portion of the transmission cable or line occurring and the level of impact based on the event model of a known pattern of matrix for a known level of likelihood or probability of impact caused by events for a transmission cable or line within a particular medium having the highest probability of matching the magnitude of the change of the IoR data over time derived from the IoR data for the portion of the transmission cable or line.

For example, the IQ error-vector data from a sensor along a portion of the transmission cable or line may be converted to the matrix of data as described above. The computing device 102, 601 may determine the classification of the event occurring near or adjacent a sensor of the transmission cable or line by comparing the matrix of data derived from the IQ error-vector data to event models of known patterns of matrix data caused by events using the prediction model 108, 430. For example, the computing device 102, 601 may determine the probability that the matrix of data derived from the IQ error-vector data matches each event model of known patterns of matrix data caused by events. The event models may be further based on the particular medium or environment for the portion of the transmission cable or line. The prediction model 108, 430 may determine the event type based on the event model having the highest probability of matching the matrix of data derived from the IQ error-vector data for the portion of the transmission cable or line.

The computing device 102, 601 may determine the severity (e.g., severity level or range of severity levels) of the event to the portion of the transmission cable or line at that location. For example, the computing device 102, 601 may determine the severity of the event to the portion of the transmission cable or line by comparing the matrix of data derived from the IQ error-vector data to event models of known patterns of severity to a transmission cable or line for a particular event and for a transmission cable or line within a particular medium or environment (e.g., a particular severity level or range of severity level, such as on a scale of 1-10) using the prediction model 108, 430. For example, the computing device 102, 601 may determine the probability that the matrix of data derived from the IQ error-vector data matches each event model of known patterns of matrix for known levels of severity to a transmission cable or line in a particular medium or environment when subjected to a particular event. The event models may be based on the particular medium or environment for the portion of the transmission cable or line. The prediction model 108, 430 may determine the severity level of the event based on the event model of severity levels or ranges having the highest probability of matching the matrix of data derived from the IQ error-vector data for the portion of the transmission cable or line.

The computing device 102, 601 may determine the probability or likelihood that the event (if it continues) will cause a negative impact (e.g., damage the transmission cable or line, disrupt or increase noise in data transmission along the transmission cable or line, sever the transmission cable or line) to the portion of the transmission cable or line at that location and the level of impact that will occur. For example, the computing device 102, 601 may determine the probability or likelihood that the event (if it continues) will cause a negative impact and the level of impact by comparing the matrix of data derived from the IQ error-vector data to event models of known patterns of impact caused by events for a transmission cable or line within a particular medium or environment (e.g., a particular likelihood or probability of impact level or range of impact levels, such as on a scale of 1-10) using the prediction model 108, 430. For example, the computing device 102, 601 may determine the probability that the matrix of data derived from the IQ error-vector data matches each event model of known patterns of matrices for known levels of likelihood or probability of impact caused by events for a transmission cable or line within a particular medium or environment and the level or impact when subjected to a particular event. The event models may be based on the particular medium or environment for the portion of the transmission cable or line. The prediction model 108, 430 may determine the likelihood or probability level of an impact on the portion of the transmission cable or line occurring and the level of impact based on the event model of a known pattern of matrix for a known level of likelihood or probability of impact caused by events for a transmission cable or line within a particular medium having the highest probability of matching the matrix of data derived from the IQ error-vector data for the portion of the transmission cable or line.

The computing device 102, 601 may output a result of the determinations (e.g., the determined event and the severity of the event or probability or likelihood the event will cause a negative impact to the transmission cable or line at the location). For example, the computing device 601 may output the result of the determinations to a display and/or a user device (e.g., a personal computer, laptop computer, smart phone, table computer, smart watch, or the like).

At 708, a response associated with the portion of the transmission cable or line may occur. For example, the response may be based on the classification of the event. For example, the response may be based on one or more of the event type, the likelihood of severity to the portion of the transmission cable or line, and/or the likelihood or the probability that the event (if it continues) will cause a negative impact (e.g., damage the transmission cable or line, disrupt or increase noise in data transmission along the transmission cable or line, sever the transmission cable or line) to the portion of the transmission cable or line. For example, the response may be caused by a computing device, such as the computing device 102 (e.g., the recommendation engine 112) or any other computing device described herein.

For example, the response may be based on comparing the determined level of severity to one or more severity thresholds. Each of the one more severity thresholds may be associated with a different response. For example, the computing device 102, 601 may determine the response to cause based on the determined level of severity satisfying one of the one or more severity thresholds or based on the highest severity level threshold that the determined level of severity satisfies, and the response associated with the threshold satisfied. For example, each severity threshold may be associated with one of the one or more responses. For example, the computing device 102, 601 may determine the response based on the type of event and the severity threshold or highest severity threshold satisfied by the determined level of severity.

For example, the response may be based on comparing the determined probability or likelihood the event will cause a negative impact to the portion of the transmission cable or line at the location to one or more impact thresholds. Each of the one more impact thresholds may be associated with a different response. For example, the computing device 102, 601 may determine the response to cause based on the determined level of probability or likelihood the event will cause a negative impact to the transmission cable or line at the location satisfying one of the one or more impact thresholds or based on the highest impact threshold that the determined level of probability or likelihood the event will cause a negative impact to the transmission cable or line at the location satisfies, and the response associated with the threshold satisfied. For example, each impact threshold may be associated with one of the one or more responses. For example, the computing device 102, 601 may determine the response based on the type of event and the impact threshold or highest impact threshold satisfied by the determined level of probability or likelihood the event will cause a negative impact to the portion of the transmission cable or line at the location.

For example, the response may comprise one or more of moving the portion of the transmission cable or line to another location, providing additional protection to the location of the portion of the transmission cable or line, rerouting data, power, communications, and/or content data from the transmission cable or line to another transmission cable or line, or dispatching a technician to the location. For example, the computing device 102, 601 may determine to reroute the data, power, communications, and/or content data being sent through the transmission cable or line to another transmission cable or line in the data, power, communications, and/or content data transmission system. For example, the computing device 102, 601 may then cause the data, power, communications, and/or content data to be rerouted through that other transmission cable or line. For example, the computing device 102, 601 may send a message or cause a message to be sent to the content server 120 to reroute the data, power, communications, and/or content data through the determined other transmission cable or line. For example, the computing device 102, 601 may determine to move the transmission cable or line or the portion of the transmission cable or line. For example, the transmission cable or line may be positioned close to are area where the event is occurring, such as a construction site 136 of FIG. 1. The computing device 102, 601 may determine that moving the portion of the transmission cable or line near the construction site 136 may be the best option for preventing subsequent damage to the transmission cable or line, as caused by the event or similar events that are likely to occur due to the construction site's proximity to the transmission cable or line. The computing device 102, 601 may cause one or more people to be dispatched to move the transmission cable or line or a portion thereof. The computing device 102, 601 may determine to provide additional protection to the transmission cable or line at the location where the event was detected by the transmission cable or line. For example, the computing device 102, 601 may cause one or more people to be dispatched to the location and to install or add additional protection to the transmission cable or line. The additional protection may be in the form of signage or notifying the cause of the event of the impacts that the event is having on the transmission cable or line and the data, power, communications, and/or content data transmission system at large.

For example, the location of the event that caused the event data on the portion of the transmission cable or line may be determined. For example, the location of the event may be determined by a computing device, such as the computing device 102 or any other computing device discussed herein. For example, a distance of the event from the portion of the transmission cable or line that received the event data may be determined. For example, the distance may be determined based on the event data and the type of the event. For example, the distance may further be determined based on the medium for the portion of the transmission cable or line. For example, the distance may further be determined based on one or more additional event data from one or more additional portions of the transmission cable or line or portions of one or more additional transmission cables or lines.

For example, the computing device 102 may determine the location of the event based on a matrix of data from multiple sensors on a transmission cable or line or from one or more sensors from multiple transmission cables or lines. For example, the computing device 102 may determine the location of the event (e.g., event 148) based on triangulation (using the location of the multiple sensors and the time (or time and magnitude) of the forces identified at each location) or another technique. For example, using triangulation, a system of equations may be evaluated to determine a location of the event based on best fit. For example, the sensors A, B, and C on transmission cable or line 130 of FIG. 1 may each detect 148A, 148B, 148C the event 148 at a different time and with a different amount of movement or vibration (e.g., a different amount of forced received or detected). Based on the magnitude of the force applied at each sensor A, B, C, as evidenced by the amount of movement or vibration of the transmission cable or line 130 at that particular sensor, and the time the event 148A-C was detected, the computing device 102 may determine the location (e.g., how far away from the transmission cable or line 130, and in which direction from the transmission cable or line 130) of the event 148.

For example, if an event is detected at only one sensor along the transmission cable or line 130, the computing device 102 may infer that the event is adjacent to or within a particular proximity to the location of the sensor along that transmission cable or line 130. For example, if an event is detected by two sensors along the transmission cable or line 130, the computing device 102 may, based on the location of each of those two sensors and the offset in time that each of those two sensors detected the event, calculate the direction of the event. However, the computing device 102 may have difficulty determining on which side of the transmission cable or line 130 the event occurred based on data from only two sensors.

For example, the computing device 102 may determine the location of the event based on IoR data from portions of a transmission cable or line or from IoR data from one or more portions of multiple transmission cables or lines. For example, the computing device 102 may determine the location of the event (e.g., event 148) based on triangulation (using the determined location (as described above) of the multiple portions of the transmission cable or line and the IoR data identified at each location) or another technique. For example, the three different portions A, B, and C of transmission cable or line 130 of FIG. 1 may each detect 148A, 148B, 148C the event 148 in the form of IoR data at a different time and with a different amount of movement or vibration (e.g., a different amount of forced received or detected). Based on the magnitude of change in the IoR data (representing the magnitude of the force applied at each portion A, B, C of the transmission cable or line and the time the event 148A-C was detected at that portion of the transmission cable or line, the computing device 102 may determine the location (e.g., how far away from the transmission cable or line 130, and in which direction from the transmission cable or line 130) of the event 148. For example, the event may comprise one of a gunshot, an explosion, construction activity, an automobile accident, a tree falling, or the like.

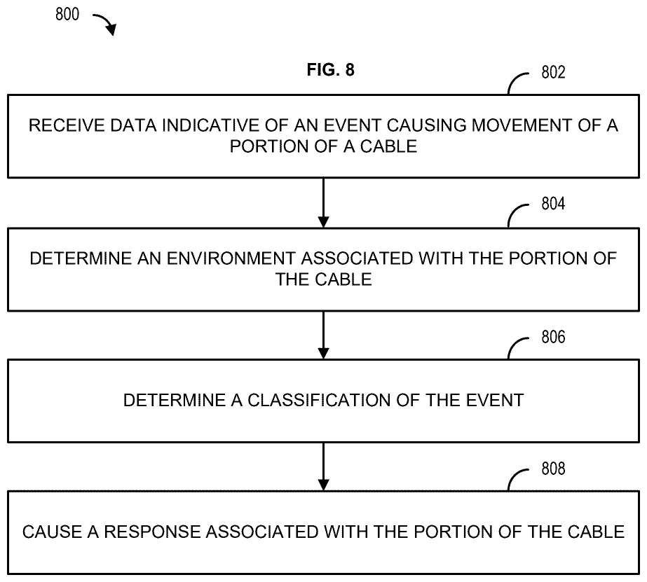

FIG. 8 shows a flowchart of an example method 800 for determining the potential for damage to a transmission cable or line caused by an event. The methods described in FIG. 8 may be completed by a computing device, such as the computing device 102 or any other computing device described herein. While the method 800 of FIG. 8 will be described as being completed by the computing device 102 this is for example purposes only.

At 802, event data indicative of an event may be received from a transmission cable or line. For example, the event data may be received by the computing device 102. For example, the computing device 102 may receive the event data from a network device, such as network device 122 communicably coupled, either directly or indirectly, to the transmission cable or line. For example, the event data may be received by the monitoring system 103 of the computing device 102. For example, the event data may be received from a portion of a transmission cable or line, such as a segment or length of transmission cable or line at a particular location. For example, the transmission cable or line may be one of a wire, a power line, a coaxial cable, another transmission line, or a fiber-optic cable. For example, the transmission cable or line may be part of the data, power, communications, and/or content data transmission system. For example, the event data may comprise one or more of IoR data associated with the portion of the transmission cable or line or IQ error-vector data associated with the portion of the transmission cable or line. For example, the IoR data or the IQ error-vector data may be detected within that portion of the transmission cable or line at the location. For example, the event data (e.g., the IoR data and/or the IQ error-vector data) may comprise one or more of an indication of a force applied to the portion of the transmission cable or line, an indication of a magnitude of the force applied to the portion of the transmission cable or line, or a duration of the force applied to the portion of the transmission cable or line.

For example, the transmission cable or line may be a fiber-optic cable, wherein portions of the fiber-optic cable (e.g., a plurality of glass fibers) are used for transmission of data, communications, and/or content data (e.g., content data carrying fibers), and another portion of the fiber-optic cable (e.g., one or more glass fibers, dark fibers, unused fibers or sensing fibers) may not be in use for transmission of data, communications, and/or content data and could optionally be used as a sensing fiber. For example, one or both of the sensing fiber and the content data carrying fiber may be used to sense for events along the length of the transmission cable or line to provide feedback to the computing device 102.

The computing device 102 may receive the IoR data (e.g., Rayleigh scattering or changes and magnitudes of the index of refraction as a function of time). The IoR data may also include a location of the portion of the transmission cable or line wherein the sensing fiber or one of the content data carrying fibers indicated the particular changes in the index of refraction.

For example, the transmission cable or line may be a wire, power line, fiber-optic cable, another transmission line, or a coaxial cable. For example, one or more portions of the transmission cable or line may be used or configured to be used as a sensor that can sense events (e.g., soundwaves, shockwaves, vibration, motion, etc.) and provide feedback to the computing device 102. For example, the generated forces of an event may cause one or more portions of the transmission cable or line to vibrate. The vibration of the one or more portions of the transmission cable or line changes the physical properties of that portion of the transmission cable or line, including the amount of Rayleigh scattering, for fiber-optic cables, or the level of impedance, for wire, power line, another transmission line, or coaxial cables, that occurs along that portion of the transmission cable or line. For example, a computing device may evaluate changes in Rayleigh scattering (the IoR data) within the particular fiber-optic elements of a fiber-optic cable to determine changes to the IQ error-vector for the portion of the fiber-optic cable and sense events. For example, the computing device may evaluate changes in impedance in a portion of a wire, power line, another transmission line, or coaxial cable to determine changes to the IQ error-vector for the portion of the transmission cable or line and sense events. The variations over time in Rayleigh scattering or impedance cause changes over time in the IQ error-vector of the code words transmitted along the transmission cable or line. The changes in Rayleigh scattering or impedance levels resulting in changes to the IQ error-vector for each frame for each subcarrier in orthogonal frequency-division multiple access (OFDMA), caused by the event and detected by the sensor in each portion of the transmission cable or line may be, via the transmission cable or line, sent to, determined by, or detected by the computing device 102 via the network 121 in the form of IQ error-vector data. The computing device 102 may receive the Rayleigh scattering data, for fiber-optic cables, or impedance levels, for wires, power line, other transmission lines, or coaxial cables, continuously or at a sampled rate from the one or more transmission cables or lines and may use that data to determine changes to IQ error-vectors and detect the event. The IoR data or impedance data received from the transmission cable or line may also include a location of the portion of the transmission cable or line that sensed the vibration.

The computing device 102 (e.g., the monitoring system 103) may also receive pre-equalization data from the network device 122. For example, when the network device 122 receives data or messages from an access point, such as access points 150A-B of FIG. 1, the network device 122 may evaluate the data or message to determine if there are linear distortions or impairments that can be reduced by having the access point adjust the access point's signal. When impairments or distortions are detected, the network device 122 sends to the access point one or more equalizer adjustment values, called coefficients, which the access point applies for upstream messages or data sent to the network device 122. The computing device 102 may determine or receive the equalizer adjustment values in the form of pre-equalization data associated with each of the one or more transmission cables or lines in the data, power, communications, and/or content data transmission system from one or more network devices, via the network 121 or another network, and may subsequently use the pre-equalization data with the IQ error-vector data when determining events occurring near one of the transmission cables or lines.

At 804, an environment for the portion of the transmission cable or line, from which the event data is received, may be determined. For example, the environment for the portion of the transmission cable or line may be determined by a computing device, such as the computing device 102 or any other computing device described herein. For example, the environment for the portion of the transmission cable or line may be determined based on the event data received or an identifier associated with the transmission cable or line or the portion of the transmission cable or line. For example, the received event data may comprise an identifier of the transmission cable or line or the portion of the transmission cable or line where the event data occurred or an indicator of the location for the portion of the transmission cable or line. For example, the computing device 102 may evaluate the topology for the data, power, communications, and/or content data transmission system in the environment for the portion of the transmission cable or line.

For example, the environment may be determined based on the sensor of the transmission cable or line from which the event data was received. For example, determining the environment for the portion of the transmission cable or line may be based on the distance between sensors on the transmission cable or line and the particular sensor that sensed the event and provided the event data (e.g., IoR data or IQ error-vector data). For example, the distance between sensors on the transmission cable or line may be based on the number of subcarriers being provided on the transmission cable or line. For example, OFDMA with 45 megahertz (MHz) width, 25 kilohertz (kHz) subcarrier spacing and 1800 subcarriers would have a time resolution (RT) of 11.1 nanoseconds and a distance resolution of 2.9 meters, as measured by the formula distance resolution (DR)=(RT)*c*VOP, where “c” is the speed of light in a vacuum and “VOP” is the velocity of propogation of the signal in the transmission medium (e.g. transmission cable or line) as compared to the speed of light (e.g., about 0.87 for coaxial cable and about 0.67 for fiber-optic cable). For example, based on the distance resolution, a sensor measure may be made by the transmission cable or line every 2.9 meters of linear length of the transmission cable or line. The actual number of sensors along the transmission cable or line may be less due to a lack of uniformity in impedance mismatches along the transmission cable or line and different in response to events along the transmission cable or line. For example, the IQ error-vector data may be normalized to determine the number of sensors and the distance between each of the sensors for subsequently determining the distance along the transmission cable or line where the sensor is located and then from that distance, the environment for the portion of the transmission cable or line.

For example, determining the environment of the portion of the transmission cable or line may comprise a medium (e.g., air, water, soil, concrete, asphalt, rock, etc.) in which the portion of the transmission cable or line extends through or is installed into. For example, the computing device 102 may determine the medium for the portion of the transmission cable or line based on an entry comprising or associated with the determined location for the portion of the transmission cable or line in the location database 107.

At 806, a classification of an event may be determined. For example, the classification of the event may be a determination of what the event was that caused the event data to occur on the portion of the transmission cable or line. For example, determining the classification of the event may comprise determining one or more of determining the type of the event, determining the severity of the event with regard to causing damage to the portion of the transmission cable or line, or determining the likelihood or the probability that the event (if it continues) will cause a negative impact (e.g., damage the transmission cable or line, disrupt or increase noise in data transmission along the transmission cable or line, sever the transmission cable or line) on the portion of the transmission cable or line. For example, the classification of the event may be determined by a computing device, such as the computing device 102, the machine-learning computing device 601 or any other computing device described herein. For example, the classification of the event may be determined based on a machine-learning model, such as a machine-learning prediction model 108, 430. For example, the classification of the event indicated at the portion of the transmission cable or line may be determined based on one or more of the event data (e.g., the IoR data and/or the IQ error-vector data) or the environment of the portion of the transmission cable or line.

For example, the IoR data received or detected from a portion of the transmission cable or line may be evaluated by the computing device 102, 601 to determine the magnitude of change of the IoR data over time and plotted along a graph over time. For example, determining the classification of an event may comprise the computing device 102, 601 determining at least one magnitude of change of a force received by the portion of the transmission cable or line. The at least one magnitude of change of a force may be determined based on the IoR data. For example, determining the classification of the event may comprise determining a duration of the magnitude of change the force. The at least one duration of the magnitude of change of the force may be determined by the computing device 102, 601 based on the IoR data. For example, the classification of the event may be determined based on the at least one magnitude of change of the force and the duration of the magnitude of change of the force on the transmission cable or line based on the IoR data.

For example, the computing device 102, 601 may determine the classification of the event occurring near or adjacent the portion of the transmission cable or line by comparing the magnitude of the change of the IoR data over time derived from the IoR data to event models of known patterns of a magnitude of change over time of IoR data caused by known events using the prediction model 108, 430. For example, the computing device 102, 601 may determine the probability that the magnitude of the change of the IoR data over time derived from the IoR data matches each event model of known patterns of magnitude of change of the IoR data over time caused by events. The event models may be further based on the particular environment for the portion of the transmission cable or line. The prediction model 108, 430 may determine the event type based on the event model having the highest probability of matching the magnitude of the change of the IoR data over time derived from the IoR data for the portion of the transmission cable or line.

The computing device 102, 601 may determine the severity (e.g., severity level or range of severity levels) of the event to the portion of the transmission cable or line at that location based on the IoR data. For example, the computing device 102, 601 may determine the severity of the event to the portion of the transmission cable or line by comparing the magnitude of the change of the IoR data over time derived from the IoR data to event models of known patterns of severity to a transmission cable or line for a particular event and for a transmission cable or line within a particular environment (e.g., a particular severity level or range of severity level, such as on a scale of 1-10) using the prediction model 108, 430. For example, the computing device 102, 601 may determine the probability that the magnitude of the change of the IoR data over time for the portion of the transmission cable or line and derived from the IoR data matches each event model of known patterns of magnitude of the change of the IoR data over time for known levels of severity to a transmission cable or line in a particular medium or environment when subjected to a particular event. The event models may be based on the particular medium or environment for the portion of the transmission cable or line. The prediction model 108, 430 may determine the severity level of the event based on the event model of severity levels or ranges having the highest probability of matching the magnitude of the change of the IoR data over time derived from the IoR data for the portion of the transmission cable or line.

The computing device 102, 601 may determine, based on the received IoR data from a portion of a transmission cable or line, the probability or likelihood that the event (if it continues) will cause a negative impact (e.g., damage the transmission cable or line, disrupt or increase noise in data transmission along the transmission cable or line, sever the transmission cable or line) to the portion of the transmission cable or line at that location and the level of impact that will occur. For example, the computing device 102, 601 may determine the probability or likelihood that the event (if it continues) will cause a negative impact and the level of impact by comparing the magnitude of the change of the IoR data over time derived from the IoR data to event models of known patterns of impact caused by events for a transmission cable or line within a particular medium or environment (e.g., a particular likelihood or probability of impact level or range of impact levels, such as on a scale of 1-10) using the prediction model 108, 430. For example, the computing device 102, 601 may determine the probability that the magnitude of the change of the IoR data over time derived from the IoR data matches each event model of known patterns of matrices for known levels of likelihood or probability of impact caused by events for a transmission cable or line within a particular medium or environment and the level or impact when subjected to a particular event. The event models may be based on the particular medium or environment for the portion of the transmission cable or line. The prediction model 108, 430 may determine the likelihood or probability level of an impact on the portion of the transmission cable or line occurring and the level of impact based on the event model of a known pattern of matrix for a known level of likelihood or probability of impact caused by events for a transmission cable or line within a particular medium having the highest probability of matching the magnitude of the change of the IoR data over time derived from the IoR data for the portion of the transmission cable or line.

For example, the IQ error-vector data from a sensor along a portion of the transmission cable or line may be converted to the matrix of data as described above. The computing device 102, 601 may determine the classification of the event occurring near or adjacent a sensor of the transmission cable or line by comparing the matrix of data derived from the IQ error-vector data to event models of known patterns of matrix data caused by events using the prediction model 108, 430. For example, the computing device 102, 601 may determine the probability that the matrix of data derived from the IQ error-vector data matches each event model of known patterns of matrix data caused by events. The event models may be further based on the particular medium or environment for the portion of the transmission cable or line. The prediction model 108, 430 may determine the event type based on the event model having the highest probability of matching the matrix of data derived from the IQ error-vector data for the portion of the transmission cable or line.

The computing device 102, 601 may determine the severity (e.g., severity level or range of severity levels) of the event to the portion of the transmission cable or line at that location. For example, the computing device 102, 601 may determine the severity of the event to the portion of the transmission cable or line by comparing the matrix of data derived from the IQ error-vector data to event models of known patterns of severity to a transmission cable or line for a particular event and for a transmission cable or line within a particular medium or environment (e.g., a particular severity level or range of severity level, such as on a scale of 1-10) using the prediction model 108, 430. For example, the computing device 102, 601 may determine the probability that the matrix of data derived from the IQ error-vector data matches each event model of known patterns of matrix for known levels of severity to a transmission cable or line in a particular medium or environment when subjected to a particular event. The event models may be based on the particular medium or environment for the portion of the transmission cable or line. The prediction model 108, 430 may determine the severity level of the event based on the event model of severity levels or ranges having the highest probability of matching the matrix of data derived from the IQ error-vector data for the portion of the transmission cable or line.

The computing device 102, 601 may determine the probability or likelihood that the event (if it continues) will cause a negative impact (e.g., damage the transmission cable or line, disrupt or increase noise in data transmission along the transmission cable or line, sever the transmission cable or line) to the portion of the transmission cable or line at that location and the level of impact that will occur. For example, the computing device 102, 601 may determine the probability or likelihood that the event (if it continues) will cause a negative impact and the level of impact by comparing the matrix of data derived from the IQ error-vector data to event models of known patterns of impact caused by events for a transmission cable or line within a particular medium or environment (e.g., a particular likelihood or probability of impact level or range of impact levels, such as on a scale of 1-10) using the prediction model 108, 430. For example, the computing device 102, 601 may determine the probability that the matrix of data derived from the IQ error-vector data matches each event model of known patterns of matrices for known levels of likelihood or probability of impact caused by events for a transmission cable or line within a particular medium or environment and the level or impact when subjected to a particular event. The event models may be based on the particular medium or environment for the portion of the transmission cable or line. The prediction model 108, 430 may determine the likelihood or probability level of an impact on the portion of the transmission cable or line occurring and the level of impact based on the event model of a known pattern of matrix for a known level of likelihood or probability of impact caused by events for a transmission cable or line within a particular medium having the highest probability of matching the matrix of data derived from the IQ error-vector data for the portion of the transmission cable or line.

The computing device 102, 601 may output a result of the determinations (e.g., the determined event and the severity of the event or probability or likelihood the event will cause a negative impact to the transmission cable or line at the location). For example, the computing device 601 may output the result of the determinations to a display and/or a user device (e.g., a personal computer, laptop computer, smart phone, table computer, smart watch, or the like).

At 808, a response associated with the portion of the transmission cable or line may occur. For example, the response may be based on the classification of the event. For example, the response may be based on one or more of the event type, the likelihood of severity to the portion of the transmission cable or line, and/or the likelihood or the probability that the event (if it continues) will cause a negative impact (e.g., damage the transmission cable or line, disrupt or increase noise in data transmission along the transmission cable or line, sever the transmission cable or line) to the portion of the transmission cable or line. For example, the response may be caused by a computing device, such as the computing device 102 (e.g., the recommendation engine 112) or any other computing device described herein.

For example, the response may be based on comparing the determined level of severity to one or more severity thresholds. Each of the one more severity thresholds may be associated with a different response. For example, the computing device 102, 601 may determine the response to cause based on the determined level of severity satisfying one of the one or more severity thresholds or based on the highest severity level threshold that the determined level of severity satisfies, and the response associated with the threshold satisfied. For example, each severity threshold may be associated with one of the one or more responses. For example, the computing device 102, 601 may determine the response based on the type of event and the severity threshold or highest severity threshold satisfied by the determined level of severity.

For example, the response may be based on comparing the determined probability or likelihood the event will cause a negative impact to the portion of the transmission cable or line at the location to one or more impact thresholds. Each of the one more impact thresholds may be associated with a different response. For example, the computing device 102, 601 may determine the response to cause based on the determined level of probability or likelihood the event will cause a negative impact to the transmission cable or line at the location satisfying one of the one or more impact thresholds or based on the highest impact threshold that the determined level of probability or likelihood the event will cause a negative impact to the transmission cable or line at the location satisfies, and the response associated with the threshold satisfied. For example, each impact threshold may be associated with one of the one or more responses. For example, the computing device 102, 601 may determine the response based on the type of event and the impact threshold or highest impact threshold satisfied by the determined level of probability or likelihood the event will cause a negative impact to the portion of the transmission cable or line at the location.

For example, the response may comprise one or more of moving the portion of the transmission cable or line to another location, providing additional protection to the location of the portion of the transmission cable or line, rerouting data, power, communications, and/or content data from the transmission cable or line to another transmission cable or line, or dispatching a technician to the location. For example, the computing device 102, 601 may determine to reroute the data, power, communications, and/or content data being sent through the transmission cable or line to another transmission cable or line in the data, power, communications, and/or content data transmission system. For example, the computing device 102, 601 may then cause the data, power, communications, and/or content data to be rerouted through that other transmission cable or line. For example, the computing device 102, 601 may send a message or cause a message to be sent to the content server 120 to reroute the data, power, communications, and/or content data through the determined other transmission cable or line. For example, the computing device 102, 601 may determine to move the transmission cable or line or the portion of the transmission cable or line. For example, the transmission cable or line may be positioned close to are area where the event is occurring, such as a construction site 136 of FIG. 1. The computing device 102, 601 may determine that moving the portion of the transmission cable or line near the construction site 136 may be the best option for preventing subsequent damage to the transmission cable or line, as caused by the event or similar events that are likely to occur due to the construction site's proximity to the transmission cable or line. The computing device 102, 601 may cause one or more people to be dispatched to move the transmission cable or line or a portion thereof. The computing device 102, 601 may determine to provide additional protection to the transmission cable or line at the location where the event was detected by the transmission cable or line. For example, the computing device 102, 601 may cause one or more people to be dispatched to the location and to install or add additional protection to the transmission cable or line. The additional protection may be in the form of signage or notifying the cause of the event of the impacts that the event is having on the transmission cable or line and the data, power, communications, and/or content data transmission system at large.

For example, the location of the event that caused the event data on the portion of the transmission cable or line may be determined. For example, the location of the event may be determined by a computing device, such as the computing device 102 or any other computing device discussed herein. For example, a distance of the event from the portion of the transmission cable or line that received the event data may be determined. For example, the distance may be determined based on the event data and the type of the event. For example, the distance may further be determined based on the medium for the portion of the transmission cable or line. For example, the distance may further be determined based on one or more additional event data from one or more additional portions of the transmission cable or line or portions of one or more additional transmission cables or lines.

For example, the computing device 102 may determine the location of the event based on a matrix of data from multiple sensors on a transmission cable or line or from one or more sensors from multiple transmission cables or lines. For example, the computing device 102 may determine the location of the event (e.g., event 148) based on triangulation (using the location of the multiple sensors and the time (or time and magnitude) of the forces identified at each location) or another technique. For example, using triangulation, a system of equations may be evaluated to determine a location of the event based on best fit. For example, the sensors A, B, and C on transmission cable or line 130 of FIG. 1 may each detect 148A, 148B, 148C the event 148 at a different time and with a different amount of movement or vibration (e.g., a different amount of forced received or detected). Based on the magnitude of the force applied at each sensor A, B, C, as evidenced by the amount of movement or vibration of the transmission cable or line 130 at that particular sensor, and the time the event 148A-C was detected, the computing device 102 may determine the location (e.g., how far away from the transmission cable or line 130, and in which direction from the transmission cable or line 130) of the event 148.

For example, if an event is detected at only one sensor along the transmission cable or line 130, the computing device 102 may infer that the event is adjacent to or within a particular proximity to the location of the sensor along that transmission cable or line 130. For example, if an event is detected by two sensors along the transmission cable or line 130, the computing device 102 may, based on the location of each of those two sensors and the offset in time that each of those two sensors detected the event, calculate the direction of the event. However, the computing device 102 may have difficulty determining on which side of the transmission cable or line 130 the event occurred based on data from only two sensors.

For example, the computing device 102 may determine the location of the event based on IoR data from portions of a transmission cable or line or from IoR data from one or more portions of multiple transmission cables or lines. For example, the computing device 102 may determine the location of the event (e.g., event 148) based on triangulation (using the determined location (as described above) of the multiple portions of the transmission cable or line and the IoR data identified at each location) or another technique. For example, the three different portions A, B, and C of transmission cable or line 130 of FIG. 1 may each detect 148A, 148B, 148C the event 148 in the form of IoR data at a different time and with a different amount of movement or vibration (e.g., a different amount of forced received or detected). Based on the magnitude of change in the IoR data (representing the magnitude of the force applied at each portion A, B, C of the transmission cable or line and the time the event 148A-C was detected at that portion of the transmission cable or line, the computing device 102 may determine the location (e.g., how far away from the transmission cable or line 130, and in which direction from the transmission cable or line 130) of the event 148. For example, the event may comprise one of a gunshot, an explosion, construction activity, an automobile accident, a tree falling, or the like.

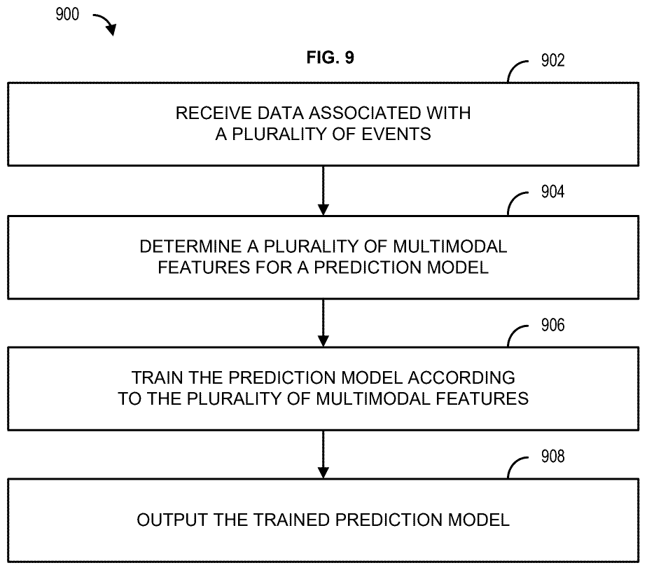

FIG. 9 shows a flowchart of an example method 900 for creating one or more machine-learning prediction models (e.g., the machine-learning prediction model 430) for determining events occurring at or near transmission cables or lines along a data, power, communication or content data transmission system. The methods described in FIG. 9 may be completed by a computing device, such as the computing device 102, 601 or any other computing device described herein. While the method 900 of FIG. 9 will be described as being completed by the computing device 601 this is for example purposes only. As another example, the training module 420 or the prediction module 430 of the system 400 may be configured to perform the method 900. The method 900 may be performed in whole or in part by a single computing device, a plurality of computing devices, and the like.

At 902, the computing device 601 may receive data. The data may be input into the computing device 601 by a user or received from another computing device (e.g., the network device 122). For example, the data may comprise a plurality of data records. For example, each data record may comprise event data for a plurality of events occurring to or near one or more transmission cables or lines of a data, power, communications, and/or content data transmission system. Each data record may comprise the event that generated the event data. Each data record may comprise the distance of the event from the portion of the transmission cable or line that detected the event data. The data may comprise the severity of the event on the portion of the transmission cable or line detecting the event data. Each data record may comprise the damage to the transmission cable or line caused by the event associated with the event data. Each data record may comprise the duration of the particular event. Each data record may comprise the medium or environment for the portion of the transmission cable or line where the event data was detected. Each data record may comprise the distance of the event from the portion of the transmission cable or line.

At 904, the computing device 601 may determine a plurality of multimodal features. The plurality of multimodal features may be determined based on the data (e.g., based on the plurality of event data). The plurality of multimodal features may be determined by the computing device 601 for use in training a prediction model. Each content item of the plurality of content items may comprise one or more of the plurality of multimodal features. For example, the plurality of multimodal features may include IoR data, change of level or IoR data over time, the duration of the event or series of events, distance of the event from the portion of the transmission cable or line, the medium of the portion of transmission cable or line detecting the event data, the environment for the portion of the transmission cable or line detecting the event data, the severity of the event to the portion of the transmission cable or line, the damage to the portion of the transmission cable or line, any combinations thereof, and/or the like. For example, the plurality of multimodal features may include IQ error-vector data, matrices derived from IQ error-vector data (as described above), duration of the event or series of events, distance of the event from the portion of the transmission cable or line, the medium of the portion of transmission cable or line detecting the event data, the environment for the portion of the transmission cable or line detecting the event data, the severity of the event to the portion of the transmission cable or line, the damage to the portion of the transmission cable or line, any combinations thereof, and/or the like. The computing device 601 may use one or more multimodal detectors to determine the one or more multimodal features that are present within each item of event data. The one or more multimodal detectors may be resident on, or other otherwise controlled by, the computing device 601.

At 906, the computing device 601 may train the prediction model. For example, the computing device 601 may train the prediction model based on the data and the plurality of multimodal features. The prediction model may be trained according to a training process, such as the one described in the method 500 of FIG. 5, described herein. As described herein, the data may comprise event data detected at a portion of transmission cable or line in a data, power, communications, and/or content data transmission system. The event data may be historical event data collected from one or more transmission cables or lines in one or more mediums or environments and/or laboratory-generated event data, as described above.

The event data detected by the portion of the transmission cable or line or a sensor associated with the portion of the transmission cable or line may be based on the event that causes the event data. For example, the event data detected by the portion of the transmission cable or line may be based on the distance of the event from the portion of the transmission cable or line. For example, the event data detected by the portion of the transmission cable or line may be based on the medium or environment for the portion of the transmission cable or line.

Each of the plurality of multimodal features may differ within each of the plurality of data records. For example, a first data record may include one or more multimodal features that are not present at all—or are present to a lesser degree—within another data record (e.g., event data for one data record may be from a portion of transmission cable or line in the ground while event data for another data record may be from a portion of transmission cable or line suspended in the air. The predetermined events may be used as the “ground truth” regarding which of the plurality of multimodal features are most correlative with a determination of the event causing the event data. For example, depending on which of the plurality of multimodal features are present within a first data record, the predetermined event for the first data record from a portion of transmission cable or line in a first medium may differ greatly from the predetermined event for another data record from a portion of transmission cable or line in a second medium. The plurality of multimodal features and the predetermined event for each item of event data may be used to train the prediction model.

At 908, the computing device 601 may output the trained prediction model. For example, the trained prediction model may be output by the computing device 601 and provided to another computing device, such as the computing device 102. The trained prediction model may be configured to provide a predicted event, predicted severity of the event, and/or predicted probability or likelihood of damage to the transmission cable or line by the event based on one or more of event data derived from the event data (e.g., matrix data derived from IQ error-vector data) and/or the medium or environment for the portion of the transmission cable or line where the event data was detected. The event data be event data that is not part of event data within a data record used to train the prediction model.

For example, a portion of transmission cable or line within a data, power, communications, and/or content data transmission network may detect event data or a sensor associated with the portion of the transmission cable or line may detect event data. The event data may be received by a network device, such as the network device 122. The network device 122 may send the event data to the computing device 102. The event data may include an indication of the location of the portion of the transmission cable or line and/or an identifier that uniquely identifies the transmission cable or line and/or the portion of the transmission cable or line where the event data was detected. The computing device 102 may receive the event data. The computing device 102 may determine the medium or environment for the portion of the transmission cable or line where the event data was detected. The computing device 102 may cause the event data and/or medium for the portion of the transmission cable or line to be provided to the trained prediction model. The trained prediction model may analyze the event data (or data derived from the event data, such as the matrix data derived from the IQ error-vector data or the amount of change of IoR over time derived from the IoR data) and determine (e.g., extract) one or more multimodal features of the plurality of multimodal features that are present within the event data. For example, the trained predication model may use one or more multimodal detectors to determine the one or more multimodal features that are present within the event data. The trained prediction model may determine a predicted event that caused the event data, the severity of the event to the portion of the transmission cable or line, and/or the probability or likelihood of damage to the transmission cable or line by the event. For example, the trained prediction model may determine the predicted event that caused the event data, the severity of the event to the portion of the transmission cable or line, and/or the probability or likelihood of damage to the portion of the transmission cable or line by the event for the event data based on the one or more multimodal features present within the event data and the medium for the portion of the transmission cable or line. The computing device may output or send the predicted event, the severity of the event to the portion of the transmission cable or line, and/or the probability or likelihood of damage to the transmission cable or line by the current event. For example, the computing device may output or send the predicted event, the severity of the event to the portion of the transmission cable or line, and/or the probability or likelihood of damage to the transmission cable or line by the current event to the user device to a display or user device. The computing device 102 may cause a response to occur based on the predicted event, the severity of the event to the portion of the transmission cable or line, and/or the probability or likelihood of damage to the transmission cable or line by the current event for the transmission cable or line or portion of the transmission cable or line substantially as described at 708 of FIG. 7.

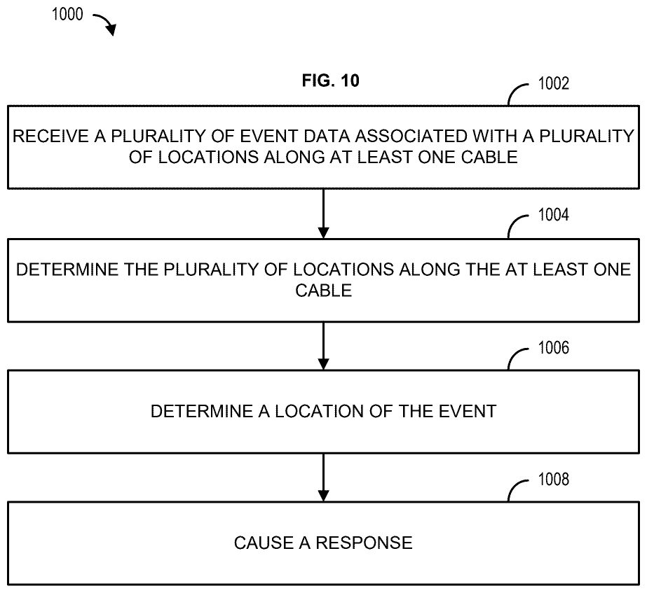

FIG. 10 shows a flowchart of an example method 1000 for determining the location of an event. The methods described in FIG. 10 may be completed by a computing device, such as the computing device 102 or any other computing device described herein. While the method 1000 of FIG. 10 will be described as being completed by the computing device 102 this is for example purposes only.

At 1002, a plurality of event data associated with a plurality of locations along at least one transmission cable or line may be received from the at least one transmission cable or line. The plurality of event data may be indicative of an event that has occurred near the at least transmission cable or line. For example, the plurality of event data may be received by the computing device 102. The computing device 102 may receive the plurality of event data from a network device, such as network device 122 communicably coupled, either directly or indirectly, to the at least one transmission cable or line. For example, the plurality of event data may be received from one transmission cable or line or a plurality of transmission cables or lines. For examples wherein the plurality of event data is received from one transmission cable or line, the plurality of event data may be received from a plurality of different locations along the one transmission cable or line. For examples where the plurality of event data is received from a plurality of transmission cables or lines, each item of event data of the plurality of event data may be received from a different transmission cable or line or at least two different transmission cables or lines. For example, each item of event data may be received from a respective portion of a transmission cable or line or one of the transmission cables or lines, such as a segment or length of transmission cable or line at a particular location. For example, the transmission cable or line may be one of a wire, power line, coaxial cable, another transmission line, or a fiber-optic cable. For example, the transmission cable or line may be part of the data, power, communication and/or content data transmission system.

For example, the event data may comprise one or more of IoR data associated with the portion of the transmission cable or line or IQ error-vector data associated with the portion of the transmission cable or line. For example, the IoR data or the IQ error-vector data may be detected within that portion of the transmission cable or line at the location. For example, the event data (e.g., the IoR data and/or the IQ error-vector data) may comprise one or more of an indication of a force applied to the portion of the transmission cable or line, an indication of a magnitude of the force applied to the portion of the transmission cable or line, or a duration of the force applied to the portion of the transmission cable or line.

For example, as shown in FIG. 1, event data 148A, 148B, 148C may be detected at locations A, B, and C on transmission cable or line 130 for the event 148 at a different time and with a different amount of movement or vibration. The locations A, B, and C on transmission cable or line 130 may be associated with sensors on the respective portions of the transmission cable or line 130 or may simply be portions of the transmission cable or line 130. While the example shows locations A, B, and C being on a single transmission cable or line 130, they one or each could be on different transmission cables or lines that detect the event 148 and generate event data.

Each of the plurality of the event data may comprise a time element or indication of the time the event data was detected on the particular portion of the transmission cable or line. The time element of indication of the time may include the hour, minute, second, and portion of the second that the particular event data was detected on the particular portion of the event.

At 1004, each of the plurality of locations associated with each of the received plurality of event data along the one or more transmission cables or lines may be determined. For example, each of the plurality of locations may be determined by a computing device, such as the computing device 102 or any other computing device described herein.

For example, each of the plurality of locations for each of the respective plurality of event data may be determined based on the respective event data received. For example, all or portions of the plurality of event data may comprise an indicator of the location on the transmission cable or line where the particular portion of the event data of the plurality of event data was detected. For example, the IoR data may comprise an indicator of the location for the portion of the transmission cable or line. For example, the computing device 102 may evaluate the topology for the data, power, communications, and/or content data transmission system in the location data to determine the location of the portion of the transmission cable or line that detected the particular portion of the event data.

For example, the location associated with particular event data may be determined based on the sensor of the transmission cable or line from which the event data was received. For example, determining the location for the portion of the transmission cable or line may be based on the distance between sensors on the transmission cable or line and the particular sensor that sensed the particular event data and provided the event data (e.g., IoR data or IQ error-vector data).

At 1006, a location of the event that caused the plurality of event data on the plurality of portions of the one or more transmission cables or lines may be determined. For example, the location of the event may be determined by a computing device, such as the computing device 102 or any other computing device discussed herein. For example, the computing device 102 may determine the location of the event based on the plurality of event data and the respective locations of the portions of the one or more transmission cables or lines that the respective event data was detected.

For example, the computing device 102 may determine the location of the event based on a matrix of data from multiple sensors on a transmission cable or line or from one or more sensors from multiple transmission cables or lines. For example, the computing device 102 may determine the location of the event (e.g., event 148) based on triangulation (using the location of the multiple sensors and the time (or time and magnitude) of the forces identified by the respective event data at each respective location along the one or more transmission cables or lines) or another technique. For example, using triangulation, a system of equations may be evaluated to determine a location of the event based on best fit. For example, with reference to FIG. 1, sensors may be positioned along respective locations A, B, and C on the transmission cable or line 130. For example, each of the sensors at each of the respective locations A, B, and C may each detect event data 148A, 148B, and 148C in response to the occurrence of the event 148 at a different time and with a different amount of movement or vibration (e.g., a different amount of forced received or detected). Based on the magnitude of the force applied at each sensor for each respective location A, B, C along the transmission cable or line 130, as evidenced by the amount of movement or vibration of the transmission cable or line 130 at that particular sensor, the respective location A, B, and C for the portion of the transmission cable or line 130 detecting the respective event data, and the time the respective event data 148A-C was detected, the computing device 102 may determine the location of the event based on triangulation of the event data 148A-C. For example, the computing device 102 may further determine (e.g., the position of the event with respect to the one or more transmission cables or lines, how far away the event is from each of the one or more transmission cables or lines and the particular location where the respective event data was detected, and in which direction the event is from each respective location where the respective event data was detected along the one or more transmission cables or lines. For example, the event may occur at a location that is separate or detached from a transmission cable or line of the one or more transmission cables or lines or may occur on a transmission cable or line of the one or more transmission cables or lines.

For example, the computing device 102 may determine the location of the event based on IoR data from portions of a transmission cable or line or from IoR data from one or more portions of multiple transmission cables or lines. For example, the computing device 102 may determine the location of the event (e.g., event 148) based on triangulation (using the determined location (as described above) of the multiple portions of the transmission cable or line the time the event data was detected at each of the respective locations, and the IoR data identified at each location) or another technique. For example, with reference to FIG. 1, the three different respective locations A, B, and C of transmission cable or line 130 may each detect event data 148A, 148B, 148C in response to the occurrence of the event 148 in the form of IoR data at a different time, and with a different amount of movement, bending, or vibration (e.g., a different amount of forced received or detected). Based on the magnitude of change in the IoR data (representing the magnitude of the force applied at each location A, B, C of the transmission cable or line 130, the location A, B, and C wherein the respective event data was detected, and the time the respective event data 148A-C was detected at that portion of the transmission cable or line, the computing device 102 may determine the location of the event based on triangulation of the event data 148A-C. For example, the computing device 102 may further determine (e.g., the position of the event with respect to the one or more transmission cables or lines, how far away the event is from each of the one or more transmission cables or lines and the particular location where the respective event data was detected, and in which direction the event is from each respective location where the respective event data was detected along the one or more transmission cables or lines. For example, the event may occur at a location that is separate or detached from a transmission cable or line of the one or more transmission cables or lines or may occur on a transmission cable or line of the one or more transmission cables or lines.

At 1008, a response may be caused. For example, the response may be caused by a computing device, such as the computing device 102 or any other computing device discussed herein. For example, the computing device 102 may cause the response based on the location of the event. For example, the computing device 102 may cause the response based on a classification of the event that caused the event data on the one or more transmission cables or lines. For example, the computing device 102 may determine the type of response to cause based on one or more of the determined location of the event or the classification of the event. For example, the type of event may comprise one or more of outputting the location of the event, displaying the location of the event, sending a message to another computing device indicating one or more of the location of the event or the classification of the event, or sending a message to law enforcement indicating one or more of the location of the event or the classification of the event. For example, the event may comprise one or more of a gunshot, a bomb, fireworks, loud music, or the like.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.
It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving, by a computing device, data indicative of an event causing movement of a portion of a cable;
determining, based on the data, a location of the portion of the cable;
determining, by a machine-learning model and based on the data and the location, a classification of the event; and
based on the classification of the event, causing a response associated with the portion of the cable.

2. The method of claim 1, wherein the data indicative of the event comprises IQ error-vector data, the method further comprising determining, based on the IQ error-vector data, the event occurred.

3. The method of claim 1, wherein determining the location of the portion of the cable further comprises determining a medium in which the portion of the cable extends through.

4. The method of claim 1, wherein the cable is one of a coaxial cable or a fiber-optic cable.

5. The method of claim 1, wherein the data comprises at least one of: Rayleigh scattering data or impedance level for the portion of the cable.

6. The method of claim 1, further comprising:
determining, based on at least one of the data or the classification of the event, a likelihood of a disruption of data through the portion of the cable; and
determining, based on the likelihood of disruption, the response.

7. The method of claim 1, further comprising determining, based on the data and the classification of the event, a distance of the event from the portion of the cable.

8. The method of claim 1, further comprising:
determining, based on the data, at least one magnitude of a force received by the portion of the cable; and
determining, based on the data, a duration of the force,
wherein determining, based on the data, the classification of the event comprises determining, based on the at least one magnitude of the force and the duration of the force, the classification of the event.

9. The method of claim 1, wherein the response is at least one of: moving the portion of the cable to another location, providing additional protection to the location of the portion of the cable, rerouting data from the cable to another cable, or dispatching a technician to the location.

10. A method comprising:
receiving, by a computing device, data indicative of an event causing movement of a portion of a cable;
determining, based on the data, an environment for the portion of the cable;
determining, by a machine-learning model and based on the data and the environment, a classification of the event; and
based on the classification of the event, causing a response associated with the portion of the cable.

11. The method of claim 10, wherein the data indicative of the event comprises IQ error-vector data, the method further comprising determining, based on the IQ error-vector data, the event occurred.

12. The method of claim 10, wherein the environment comprises at least one of: air, soil, concrete, or rock.

13. The method of claim 10, wherein the data comprises at least one of: Rayleigh scattering data or impedance level for the portion of the cable.

14. The method of claim 10, further comprising:
determining, based the data and the classification of the event, a likelihood of a disruption of data through the portion of the cable; and
determining, based on the likelihood of disruption, the response.

15. The method of claim 10, further comprising determining, based on the data and the classification of the event, a distance of the event from the portion of the cable.

16. The method of claim 10, further comprising:
determining, based on the data, at least one magnitude of a force received by the portion of the cable; and
determining, based on the data, a duration of the force,
wherein determining, based on the data, the classification of the event comprises determining, based on the at least one magnitude of the force and the duration of the force, the classification of the event.

17. A method comprising:
receiving, by a computing device, a plurality of event data associated with a plurality of locations along at least one cable, the plurality of event data indicative of an event causing movement of at least one cable;
determining, based on the plurality of event data, the plurality of locations along the at least one cable;
determining, based on the plurality of event data and the plurality of locations along the at least one cable, a location of the event; and
based on determining the location of the event, causing a response.

18. The method of claim 17, further comprising determining, by a machine-learning model and based on at least one of the plurality of event data, a classification of the event, wherein the response is further determined based on the classification of the event.

19. The method of claim 17, further comprising determining a medium for a portion of the cable associated with the at least one of the plurality of event data, wherein determining the classification of the event is further based on the medium.

20. The method of claim 17, wherein the cable is one of coaxial cable or fiber-optic cable.
